(19) United States
(12) Patent Application Publication
(10) Pub. No.: US 2010/0112452 A1
(43) Pub. Date: May 6, 2010

(54) BATTERY CURRENT COLLECTOR, METHOD FOR PRODUCING THE SAME, AND NON-AQUEOUS SECONDARY BATTERY

(76) Inventors: Takuhiro Nishimura, Osaka (JP); Yasutaka Kogetsu, Osaka (JP); Takashi Nonoshita, Osaka (JP); Tatsuki Hiraoka, Osaka (JP)

Correspondence Address: MCDERMOTT WILL & EMERY LLP, 600 13TH STREET, NW, WASHINGTON, DC, 20005-3096, US

(21) Appl. No.: 12/532,355

(22) PCT Filed: Oct. 27, 2008
(86) PCT No.: PCT/JP2008/003050

§ 371 Date: Sep. 21, 2009

(30) Foreign Application Priority Data
Oct. 30, 2007 (JP) 2007-281182
Feb. 29, 2008 (JP) 2008-050815

(51) Int. Cl. H01M 4/58; H01M 4/02

(52) U.S. Cl. 429/231.95; 429/209; 29/623.1; 29/623.5

(57) ABSTRACT

The invention relates to a battery current collector including a metal foil for carrying at least a positive electrode active material or a negative electrode active material. At least one side of the metal foil has a compressed base plane and non-compressed protrusions arranged at a predetermined interval, and the non-compressed protrusions are formed at the same time as formation of the base plane. The surface roughness of the base plane is different from the surface roughness of the protrusions, and the surface roughness of the base plane is preferably an arithmetic mean roughness of 0.8 μm or less.

### TECHNICAL FIELD

The invention relates to a battery current collector, a method for producing the same, and a non-aqueous secondary battery. More particularly, it relates to a battery current collector that can be advantageously used in non-aqueous type secondary batteries such as lithium secondary batteries, and a method for producing the same, and a non-aqueous secondary battery using the same.

### BACKGROUND ART

Lithium ion secondary batteries as non-aqueous type secondary batteries (hereinafter referred to as simply lithium secondary batteries) have characteristics of high voltage and high capacity, and their size and weight can be reduced relatively easily. Therefore, they are mainly used as the power source for portable electronic devices, and such use has been significantly increasing recently. A typical lithium secondary battery uses, for example, a carbonaceous material capable of absorbing and desorbing lithium as a negative electrode active material, and uses a composite oxide containing transition metal and lithium, such as LiCoO₂, as a positive electrode active material, thereby achieving high voltage and high capacity. However, with the increase in functionality of portable electronic devices and the power consumed thereby, it is desired to further reduce the performance deterioration of lithium secondary batteries due to charge/discharge cycles.

An electrode plate, which is a power generating element of a lithium secondary battery, is produced, for example, by forming an electrode mixture layer composed mainly of an active material on one or both sides of a current collector made of metal foil. The electrode mixture layer is formed by applying an electrode mixture paint including a positive electrode active material or negative electrode active material onto one or both sides of a current collector, drying it, and press forming it. The electrode mixture paint is prepared by mixing and dispersing a positive electrode active material or negative electrode active material, a binder, and if necessary, a conductive agent in a dispersion medium.

One cause of performance deterioration due to charge/discharge cycles is decreased adhesion between the current collector and the electrode mixture layer. In lithium secondary batteries, due to charge/discharge, the electrodes repeatedly expand and contract. This decreases the adhesion at the interface between the current collector and the electrode mixture layer, thereby causing the electrode mixture layer to separate from the current collector.

Therefore, in order to suppress performance deterioration due to charge/discharge cycles, it is necessary to increase the adhesion between the current collector and the electrode mixture layer. For this purpose, the surface area of the current collector is increased (see, for example, Patent Documents 1 and 2). More specifically, the surface of the current collector is commonly roughened by etching the surface of the current collector or depositing constituent metal on the surface by electrodeposition.

There has also been proposed a method of causing fine particles to collide with the surface of a rolled copper foil at a high speed to form minute protrusions and depressions on the surface (see Patent Document 3).

There has also been proposed a method of irradiating a metal foil with a laser beam to form protrusions and depressions so that the surface roughness (arithmetic mean roughness) is 0.5 to 10 μm (see Patent Document 4).

There has also been proposed a method as illustrated in FIG. 14. An electrode mixture paint is applied onto a current collector 102 unwound from an unwinding roller 104 by an application device 101. The paint is then dried by a dryer 103 and rewound onto a rewinding roller 105. It is proposed to form protrusions and depressions on the surface of the current collector 102 by guide rollers 106 and 107 (see Patent Document 5; also see Patent Document 6 for rolling using rollers). In the method of Patent Document 5, protrusions and depressions are formed on the surfaces of the pair of guide rollers 106 and 107 guiding the current collector 102.

Also, in order to increase the adhesion between the current collector and the active material layer and electrical conductivity, it is proposed to form protrusions and depressions on both sides of a current collector, as illustrated in FIGS. 15A, 15B, 15C, 15D, and 15E (see Patent Document 7). In the current collectors illustrated in FIGS. 15A to 15E, protrusions and depressions are regularly formed on both sides of the current collector in such a manner that where one side is recessed, the other side is raised.

Another known method for producing an electrode plate, which is a power generating element of a lithium secondary battery, is a method of forming a thin film of an active material mixture layer on a current collector by electrolytic plating, vacuum deposition, or the like. In this method, it is also necessary to increase the adhesion between the current collector and the active material mixture layer in order to obtain a stable battery. It is thus proposed to use a current collector made of a metal not alloyable with lithium and set the value: ((the surface roughness Ra of the active material mixture layer)-(the surface roughness Ra of the current collector)) to 0.1 μm or less (see Patent Document 8).

Patent Document 1: Japanese Laid-Open Patent Publication No. 2005-38797

Patent Document 2: Japanese Laid-Open Patent Publication No. Hei 7-272726

Patent Document 3: Japanese Laid-Open Patent Publication No. 2002-79466

Patent Document 4: Japanese Laid-Open Patent Publication No. 2003-258182

Patent Document 5: Japanese Laid-Open Patent Publication No. Hei 8-195202

Patent Document 6: Japanese Laid-Open Patent Publication No. Hei 10-263623

Patent Document 7: Japanese Laid-Open Patent Publication No. 2002-270186

Patent Document 8: Japanese Laid-Open Patent Publication No. 2002-279972

Patent Document 9: Japanese Laid-Open Patent

Publication No. 2002-313319

### DISCLOSURE OF THE INVENTION

### Problem To be Solved by the Invention

However, for example, according to the conventional technique of Patent Document 3, a current collector having partially random protrusions and depressions can be formed, but it is difficult to form protrusions and depressions uniformly in the width direction and longitudinal direction of the current collector, since there are variations in the speed of the fine particles sprayed from the nozzle.

Also, according to the conventional technique of Patent Document 4, depressions are formed by irradiating the metal foil with a laser beam to partially heat and evaporate the metal. At this time, by continuously irradiating the metal foil with the laser beam, protrusions and depressions can be formed throughout the metal foil. However, since the laser beam is applied linearly, heat equal to or higher than the melting point of the metal is partially applied. It is thus difficult to prevent the metal foil from having problems such as corrugation, wrinkles, or warpage. Further, when a metal foil with a thickness of 20 μm or less, such as a current collector for a lithium secondary battery, is subjected to laser machining, the metal foil may be perforated due to variations in laser power.

Also, in the conventional techniques of Patent Documents 5 and 7, the metal foil is so structured that the backside of a depression on the surface side is inevitably a protrusion, and it is thus difficult to prevent the metal foil from becoming corrugated, wrinkled, warped, etc., during the formation of the protrusions and depressions on the metal foil. Also, according to the technique of Patent Document 5, since a punched metal with an open area ratio of 20% or less is embossed to form protrusions and depressions, the strength of the current collector lowers, which may cause a problem of breakage of the electrode plate.

Also, in the conventional technique of Patent Document 8, by using a current collector made of a metal not alloyable with lithium and setting the value: ((the surface roughness Ra of the active material mixture layer)−(the surface roughness Ra of the current collector)) to 0.1 μm or less, the adhesion between the current collector and the active material mixture layer is stabilized. However, if the active material mixture layer contains a metal which expands significantly upon lithium intercalation, the adhesion between the current collector and the active material mixture layer becomes weak. As a result, the electrode plate may become wrinkled, thereby causing a problem of deterioration of charge/discharge cycle characteristics.

In order to form protrusions and depressions uniformly in the width direction and longitudinal direction of a current collector, it is preferable to use a tool with such protrusions and depressions formed on the work surface for rolling the current collector. In terms of productivity, it is preferable to use rollers for rolling.

In particular, when the object to be worked is the current collector of the above-described lithium secondary battery, it is preferable, in terms of increasing battery life, to form a large number of protrusions at an equal pitch in a regular arrangement on the surface of the metal foil, which is the material of the current collector, and to deposit an active material on each of the protrusions in columnar shape to form a thin film of the active material (see Patent Document 9).

Hence, in working the current collector, it is necessary to form a large number of depressions corresponding to the above-mentioned protrusions in a roller in an arrangement that is uniform in the width direction and longitudinal direction. As the method of forming a large number of depressions in a regular arrangement, a method of forming the depressions in a roller by laser machining is preferable in terms of working speed and working accuracy.

According to laser machining, depressions are formed by irradiating the outer surface of a roller with a laser beam to instantaneously heat the laser-beam irradiated portion to a high temperature, thereby sublimating the material of that portion. It should be noted that a roller used to compress a metal foil to form protrusions on the surface needs to be made of a very hard metal material (e.g., super hard alloy, powder high speed steel, forged steel). When such a roller is subjected to laser machining to form depressions, the sublimated material may re-adhere to the open edges of the depressions to form burrs.

When a roller with burrs formed on the open edges of the depressions is used to compress a metal foil, the metal foil undesirably adheres to the burrs. Upon completion of the compression process, when the metal foil is pulled out of the burrs, the metal foil becomes deformed, resulting in wrinkles, warpage, and the like. Also, when the adhesion is strong, the portion of the metal foil adhering to the burrs is torn off, posing a problem. When the metal foil breaks in this way, the broken pieces adhere to the outer surface of the roller, and prevent correct formation of protrusions at that portion, posing another problem. This causes a decrease in production efficiency.

In view of the above-noted problems associated with conventional art, an object of the invention is to provide: a battery current collector that comprises a metal foil that is pressed to form protrusions on the surface, has increased strength, and is capable of suppressing the deterioration of the secondary battery using the current collector due to charge/discharge cycles; a method for producing the same; and a non-aqueous secondary battery.

Another object of the invention is to provide: a battery current collector capable of increasing the production efficiency in producing battery current collectors comprising a metal foil that is pressed to form protrusions on the surface; a method for producing the same; and a non-aqueous secondary battery.

### Means for Solving the Problem

In order to achieve the above-mentioned objectives, the invention is directed to a battery current collector including a metal foil for carrying at least a positive electrode active material or a negative electrode active material. At least one side of the metal foil has a compressed base plane and non-compressed protrusions arranged at a predetermined interval, the non-compressed protrusions being formed at the same time as formation of the base plane. The surface roughness of the base plane is different from the surface roughness of the protrusions.

In a preferable embodiment of the battery current collector of the invention, the surface roughness of the protrusions is greater than the surface roughness of the base plane. Also, in a more preferable embodiment, the surface roughness of the base plane is an arithmetic mean roughness of 0.8 μm or less.

Also, the invention provides a method for producing a battery current collector, including the step of pressing at least one side of a metal foil to form protrusions on the at least one side of the metal foil at a predetermined interval. The step includes pressing the metal foil with a work tool having depressions in a work surface at a predetermined interval, thereby to form a compressed base plane at an area of the metal foil corresponding to an area of the work surface excluding the depressions, and at the same time, to form the protrusions at areas of the metal foil corresponding to the depressions, the protrusions being not compressed and having a surface roughness different from that of the base plane.

In a preferable embodiment of the method for producing a battery current collector of the invention, the method includes forming the base plane so that the surface roughness thereof is an arithmetic mean roughness of 0.8 μm or less.

Also, in a preferable embodiment of the method for producing a battery current collector of the invention, the method includes pressing the metal foil with a pair of rollers as the work tool, at least one of the pair of rollers having the depressions.

Also, in another preferable embodiment of the invention, the method includes placing a lubricant between the work surface of the roller and the metal foil and then pressing the metal foil.

Also, in another preferable embodiment of the invention, the method includes heating the roller to 50 to 120° C.

Also, in another preferable embodiment of the invention, the method includes using at least one selected from the group consisting of myristic acid, stearic acid, caprylic acid, capric acid, lauric acid, oleic acid, and ether compounds as the lubricant.

In a more preferable embodiment of the invention, the method includes: mixing the lubricant with at least one of an organic dispersion medium and an aqueous dispersion medium to form a solution; applying the solution onto at least one of the metal foil and the work surface of the roller; and drying it so that the lubricant is placed between the metal foil and the work surface of the roller.

Also, in another preferable embodiment of the invention, the method includes using the work tool, wherein a cross-section of each of the depressions perpendicular to the work surface has a taper so that the width of the cross-section parallel to the work surface gradually decreases from an opening of the depression to a bottom of the depression. It is preferable to use the work tool wherein the taper has an angle of 5 to 60°.

Also, in a preferable embodiment of the invention, the method includes using the work tool wherein an edge of an opening of each of the depressions has a curvature radius of 3 to 100 μm.

Also, in a preferable embodiment of the invention, the method includes using the work tool wherein a pressing area is defined as the area obtained by subtracting the area of openings of the depressions from the area of the whole work surface, and the ratio of the pressing area to the area of openings of the depressions is from 0.05 to 0.85.

Also, in another preferable embodiment of the invention, the method includes using the roller wherein the roller includes a core portion and an outer portion, the core portion includes a quenched alloy composed mainly of iron, and the outer portion includes a quenched alloy composed mainly of iron, a super hard alloy, or ceramics with a porosity of 5% or less.

Preferably, the method includes using the roller wherein the work surface comprises a coating of ceramics with a porosity of 5% or less or a super hard alloy. Also, more preferably, the method includes using the roller, wherein the ceramics is formed by CVD, PVD, or thermal spraying of at least one selected from the group consisting of: amorphous carbon; diamond-like carbon; titanium oxide; titanium nitride; titanium carbonitride; and oxides, nitrides, and carbides composed mainly of zirconium, silicon, chromium, and aluminum.

Also, preferably, the method includes using the roller wherein the super hard alloy is tungsten carbide having a mean particle size of 5 μm or less and containing at least cobalt or nickel as a binder, and the super hard alloy has a Rockwell A scale hardness of 82 or more and is formed by CVD, PVD, or thermal spraying.

Also, in a preferable embodiment of the invention, the method includes using the work tool, wherein an edge of opening of each of the depressions has a bump with a height of 0.08 to 0.3 μm from the work surface.

Also, in another preferable embodiment of the invention, the method includes using the work tool wherein the bump has a curvature radius of 15 μm or less.

Also, in a preferable embodiment of the invention, the method includes using the work tool wherein the depressions are formed by irradiating the work surface with a laser beam. Preferably, the method includes using the work tool, wherein an opening of each of the depressions is shaped like any one of a substantial circle, a substantial oval, a substantial rhombus, a substantial rectangle, a substantial square, a substantially regular hexagon, and a substantially regular octagon.

Also, the invention provides a non-aqueous secondary battery including: a positive electrode plate including a positive electrode current collector and a positive electrode mixture paint applied to the positive electrode current collector, the positive electrode mixture paint including an active material comprising at least a lithium-containing composite oxide, a conductive agent, and a binder which are dispersed in a dispersion medium; a negative electrode plate including a negative electrode current collector and a negative electrode mixture paint applied to the negative electrode current collector, the negative electrode mixture paint including an active material comprising at least a material capable of retaining lithium and a binder which are dispersed in a dispersion medium; a separator; and an electrolyte including a non-aqueous solvent. At least one of the positive electrode current collector and the negative electrode current collector is the battery current collector as recited above.

### Effect of the Invention

According to the invention, the formation of non-compressed protrusions on a surface at a predetermined interval can increase the strength of the battery current collector. Also, since the protrusions are not compressed, the adhesion of an active material to the protrusions can be enhanced. It is therefore possible to suppress the separation of the active material from the current collector when the active material repeatedly expands and contracts due to charge/discharge of the battery.

Also, the invention uses a work tool having, in a work surface for a metal foil, depressions corresponding to the protrusions to be formed on the metal foil. The open edges of the depressions have bumps with a height of 0.08 to 0.3 μm from the work surface. The bumps are formed, for example, by grinding burrs that are formed on the open edges of the depressions when the depressions are formed in the work surface of the work tool. Hence, the undesirable adhesion between the metal foil and the burrs can be suppressed. It is therefore possible to suppress the occurrence of problems such as wrinkles/warpage of the metal foil and tear starting from wrinkles/warpage. It is also possible to prevent the undesirable adhesion of broken pieces of the metal foil to the burrs, and hence prevent the work tool of such condition from failing to form protrusions having a desirable shape. Further, due to the provision of the bumps formed from the burrs, indentations with a suitable depth are formed at the foot of the protrusions of the metal foil. When an active material is disposed on the protrusions, the active material is filled into the indentations. As a result, the active material is unlikely to separate from the surface of the battery current collector.

### BRIEF DESCRIPTION OF THE DRAWINGS

FIG. 1A is a perspective view showing the appearance of a roller which is used as a work tool in a method for producing a battery current collector in accordance with one embodiment of the invention;

FIG. 1B is a perspective view showing the outer surface (work surface) of the roller in detail;

FIG. 2 is a perspective view showing an example of how the roller is used;

FIG. 3 is a plan view of a battery current collector produced by using the roller;

FIG. 4 is a transverse sectional view of an example of the battery current collector;

FIG. 5 is a transverse sectional view of another example of the battery current collector;

FIG. 6 is a perspective view of a depression formed in the work surface of the roller;

FIG. 7A is a sectional view showing a metal foil, an upper roller, and a lower roller immediately before working in an exemplary process of producing the battery current collector;

FIG. 7B is a sectional view showing the metal foil, upper roller, and lower roller in an early stage of the working in the exemplary process of producing the battery current collector;

FIG. 7C is a sectional view showing the metal foil, upper roller, and lower roller upon completion of the working in the exemplary process of producing the battery current collector;

FIG. 8A is a sectional view showing a metal foil, an upper roller, and a lower roller immediately before working in an another exemplary process of producing the battery current collector;

FIG. 8B is a sectional view showing the metal foil, upper roller, and lower roller in an early stage of the working in the exemplary process of producing the battery current collector;

FIG. 8C is a sectional view showing the metal foil, upper roller, and lower roller upon completion of the working in the exemplary process of producing the battery current collector;

FIG. 9 is a perspective view of a cut section of an exemplary non-aqueous secondary battery in accordance with one embodiment of the invention;

FIG. 10 is a sectional view showing an initial state of a depression formed in the work surface of the roller;

FIG. 11 is a sectional view showing the depression with a burr formed around the depression;

FIG. 12 is a perspective view showing a protrusion of the battery current collector in detail;

FIG. 13 is a sectional view schematically showing how an active material is attached to the surface of the battery current collector;

FIG. 14 is a schematic view of an apparatus for producing a battery in a conventional example;

FIG. 15A is a perspective view showing a first mode of a battery current collector in another conventional example;

FIG. 15B is a perspective view showing a second mode of a battery current collector in another conventional example;

FIG. 15C is a perspective view showing a third mode of a battery current collector in another conventional

FIG. 15D is a perspective view showing a fourth mode of a battery current collector in another conventional example; and

FIG. 15E is a perspective view showing a fifth mode of a battery current collector in another conventional example.

### BEST MODE FOR CARRYING OUT THE INVENTION

A first aspect of the invention relates to a battery current collector including a metal foil for carrying at least a positive electrode active material or a negative electrode active material. At least one side of the metal foil has a compressed base plane and non-compressed protrusions arranged at a predetermined interval, the non-compressed protrusions being formed at the same time as formation of the base plane. The surface roughness of the base plane is different from the surface roughness of the protrusions.

According to the first aspect of the invention with the above configuration, the adhesion of the positive electrode active material or negative electrode active material (hereinafter collectively referred to as “active material” unless they need to be distinguished) to the base plane is usually weaker than the adhesion to the non-compressed protrusions. This makes it possible to perform the process of removing only the active material disposed on the base plane while leaving only the active material disposed on the protrusions.

As a result, the active material is disposed only on the protrusions arranged at a predetermined interval. Hence, even when the active material expands during charge, it is possible to prevent or suppress mutual interference of the active material disposed on the respective protrusions. It is thus possible to suppress the separation of the active material from the current collector. As a result, it is possible to suppress the performance deterioration of the non-aqueous type secondary battery due to repeated charge/discharge.

Also, in a second aspect of the invention, the surface roughness of the protrusions is greater than the surface roughness of the base plane. This configuration ensures that in heightening the capacity of the non-aqueous secondary battery, the adhesion of the active material disposed on the base plane to the base plane is weaker than the adhesion of the active material disposed on the non-compressed protrusions to the protrusions. It is therefore possible to perform the above-mentioned process of removing only the active material disposed on the base plane while leaving only the active material disposed on the protrusions. As a result, it is possible to suppress the performance deterioration of the non-aqueous secondary battery due to repeated charge/discharge.

At this time, in a third aspect of the invention, the surface roughness of the base plane is an arithmetic mean roughness of 0.8 μm or less.

A fourth aspect of the invention relates to a method for producing a battery current collector, including pressing at least one side of a metal foil to form protrusions on the at least one side of the metal foil at a predetermined interval. In this aspect, the metal foil is pressed with a work tool having depressions in the work surface at a predetermined interval, thereby to form a compressed base plane at an area of the metal foil corresponding to an area of the work surface excluding the depressions, and at the same time, to form the protrusions at areas of the metal foil corresponding to the depressions, the protrusions being not compressed and having a surface roughness different from that of the base plane.

Since the protrusions are not compressed, they are highly durable, and the formation of such protrusions at a predetermined interval increases the strength of the metal foil. This can prevent the current collector from becoming partially deformed or warped in the step of forming protrusions on the surface of the metal foil to provide a battery current collector (hereinafter referred to as simply a “current collector”) and the step of disposing an active material on the protrusions of the current collector. It is also possible to suppress separation of the active material from the current collector in the step of disposing the active material on the protrusions of the current collector and subsequent steps such as the step of slitting the current collector with the active material to a predetermined width.

Also, the base plane is formed among the protrusions arranged at a predetermined interval, and thus, essentially the same effect as that described with respect to the first aspect of the invention can be obtained.

At this time, in a fifth aspect of the invention, the base plane is formed so that the surface roughness thereof is an arithmetic mean roughness of 0.8 μm or less.

In a sixth aspect of the invention, the metal foil is pressed with a pair of rollers as the work tool, at least one of the pair of rollers having the depressions. In this way, by using a pair of rollers for pressing the metal foil, the long metal foil sheet can be continuously pressed to produce a current collector. Thus, the productivity increases.

In a seventh aspect of the invention, a lubricant is placed between the work surface of the roller and the metal foil, and then the metal foil is pressed. In this way, by pressing the metal foil, with the solid lubricant placed between the metal foil and the work surface, i.e., the outer surface, of the roller serving as the work tool, it is possible to prevent the undesirable adhesion between the roller and the metal foil, and continuously form the protrusions on the surface of the metal foil. In particular, when a solid lubricant comprising a fine powder is used as the lubricant, the resistance of the metal foil to compression in the depressions of the roller is reduced. It is thus possible to suppress variations in the height and shape of the protrusions formed.

Also, if the lubricant is a fine powder, minute recesses or pores in the work surface of the roller are filled with the lubricant. This improves the releasability of the current collector from the roller. As a result, the friction coefficient of work surface of the roller decreases, and the roller life is expanded. Further, for example, when one of the pair of rollers is a roller with depressions and the other is a roller with a flat work surface having no depressions, the difference in the coefficient of friction between the respective rollers and the metal foil is reduced. It is thus possible to prevent the current collector from having problems such as corrugation, wrinkles, and warpage due to compression process. Therefore, in the step of disposing the active material on the current collector, it is possible to prevent the current collector from becoming partially deformed or warped.

In an eighth aspect of the invention, the roller is heated to 50 to 120° C. This promotes the dispersion of the lubricant. Thus, the lubricant whose thickness is on the order of nanometers can be attached uniformly to the work surface of the roller. As a result, the releasability of the current collector from the roller can be further improved.

In a ninth aspect of the invention, the lubricant is at least one selected from the group consisting of myristic acid, stearic acid, caprylic acid, capric acid, lauric acid, and oleic acid, and ether compounds. Also, in a tenth aspect of the invention, the lubricant is mixed with at least one of an organic dispersion medium and an aqueous dispersion medium to form a solution; the solution is applied onto at least one of the metal foil and the work surface of the roller; and it is dried so that the lubricant is placed between the metal foil and the work surface of the roller.

That is, in this aspect, at least one selected from the group consisting of myristic acid, stearic acid, caprylic acid, capric acid, lauric acid, and oleic acid, and ether compounds is mixed with at least one of an organic dispersion medium and an aqueous dispersion medium for dilution, and a surfactant is added thereto. The resulting solution is applied onto at least one of the work surface of the roller and the metal foil, and then dried for use as the lubricant. In this way, a lubricant film comprising a fine powder can be formed on at least one of the work surface of the roller and the metal foil, thereby permitting a continuous compression process for forming protrusions on the metal foil surface.

Also, the resistance of the metal foil to compression in the depressions of the roller is reduced. It is thus possible to suppress variations in the height and shape of the protrusions formed. Further, by closing the minute recesses or pores in the work surface of the roller, the releasability of the metal foil from the roller can be improved, thereby reducing the friction coefficient of work surface of the roller and expanding the roller life.

In an eleventh aspect of the invention, the process is performed using the work tool wherein a cross-section of each of the depressions perpendicular to the work surface has a taper so that the width of the cross-section parallel to the work surface gradually decreases from the opening of the depression to the bottom of the depression. This configuration can further improve the releasability of the metal foil from the work tool, since the protrusions formed in the depressions by pressurization can be easily removed from the depressions. As a result, it is possible to prevent the current collector from becoming wrinkled or the like.

In a twelfth aspect of the invention, the angle of the taper is 5 to 60°. By adjusting the largest diameter of openings of the depressions in this range and adjusting the angle of the taper in this range, the releasability can be optimized.

In a thirteenth aspect of the invention, the open edge of each of the depressions has a curvature radius of 3 to 100 μm. If the curvature radius of the opening edge is less than 3 μm, the movement of the constituent material of the metal foil into the depressions is impeded, and thus protrusions of desired height are not formed. On the other hand, if the curvature radius exceeds 100 μm, the pressure applied to the portion of the metal foil to be compressed becomes uneven. Also, the plastic deformation of the metal foil from the compressed portion to the non-compressed portions (portions corresponding to the depressions is unlikely to occur beyond the border thereof. In addition, the volume movement of the metal foil material into the non-compressed portions due to plastic deformation is unlikely to occur, thereby making it difficult to form protrusions of sufficient height.

In a fourteenth aspect of the invention, the process is performed using the work tool wherein a pressing area is defined as the area obtained by subtracting the area of openings of the depressions from the area of the whole work surface, and the ratio of the pressing area to the area of openings of the depressions is from 0.05 to 0.85. This can suppress problems such as wrinkles/warpage of the current collector and tear starting form wrinkles/warpage. It is also possible to suppress the separation of the active material from the current collector produced using the work tool. Further, the life of the work tool can be expanded.

A fifteenth aspect of the invention uses the roller wherein the roller includes a core portion and an outer portion, the core portion comprises a quenched alloy composed mainly of iron, and the outer portion comprises a quenched alloy composed mainly of iron, a super hard alloy, or ceramics with a porosity of 5% or less. This can suppress variations in the shape of the depressions. As a result, it is possible to reduce variations in the strength of the current collector with a large number of non-compressed protrusions and the warpage thereof.

A sixteenth aspect of the invention uses the roller wherein the work surface comprises a coating of the above-mentioned ceramics or the above-mentioned super hard alloy. With this configuration, when the work surface of the roller is worn down or the roller becomes defective due to jamming of foreign matter, the roller can be reconditioned by re-coating. As a result, production costs can be reduced.

Also, a seventeenth aspect of the invention uses the roller wherein the ceramics is formed by CVD, PVD, or thermal spraying of at least one selected from the group consisting of: amorphous carbon; diamond-like carbon; titanium oxide; titanium nitride; titanium carbonitride; and oxides, nitrides, and carbides composed mainly of zirconium, silicon, chromium, and aluminum. This configuration can reduce variations in the strength of the current collector due to the material thereof, and the warpage thereof. Also, depending on the material of the current collector, various surface treatment materials can be coated by various methods to reduce the friction coefficient of the work surface of the roller and expand the roller life.

Also, in an eighteenth aspect of the invention, the process is performed using the roller wherein the super hard alloy is tungsten carbide having a mean particle size of 5 μm or less and containing at least cobalt or nickel as a binder, and the super hard alloy has a Rockwell A scale hardness of 82 or more and is formed by CVD, PVD, or thermal spraying. This can reduce variations in the strength of the current collector due to the material thereof, and the warpage thereof. Also, depending on the material of the current collector, various surface treatment materials can be coated by various methods to reduce the friction coefficient of the work surface of the roller and expand the roller life.

Also, a nineteenth aspect of the invention uses the work tool wherein the open edge of each of the depressions has a bump with a height of 0.08 to 0.3 μm from the work surface. This can suppress the separation of the active material from the protrusions more effectively.

Also, a twentieth aspect of the invention uses the work tool wherein the bumps have a curvature radius of 15 μm or less. This can reduce the resistance of the metal foil to compression in the depressions. It is thus possible to suppress variations in the height and shape of the protrusions.

Also, a twenty first aspect of the invention uses the work tool wherein the depressions are formed by irradiating the work surface with a laser beam. Hence, a large number of depressions can be formed in the work surface of the work tool in a regular pattern. Also, a twenty second aspect of the invention uses a work tool wherein the opening of each of the depressions is shaped like any one of a substantial circle, a substantial oval, a substantial rhombus, a substantial rectangle, a substantial square, a substantially regular hexagon, and a substantially regular octagon.

Also, in a twenty third aspect of the invention, a non-aqueous secondary battery includes: a positive electrode plate including a positive electrode current collector and a positive electrode mixture paint applied to the positive electrode current collector, the positive electrode mixture paint including an active material comprising at least a lithium-containing composite oxide, a conductive agent, and a binder which are dispersed in a dispersion medium; a negative electrode plate including a negative electrode current collector and a negative electrode mixture paint applied to the negative electrode current collector, the negative electrode mixture paint including an active material comprising at least a material capable of retaining lithium and a binder which are dispersed in a dispersion medium; a separator; and an electrolyte including a non-aqueous solvent. At least one of the positive electrode current collector and the negative electrode current collector is the above-described battery current collector.

### Embodiment 1

Referring now to drawings, embodiments of the invention are described.

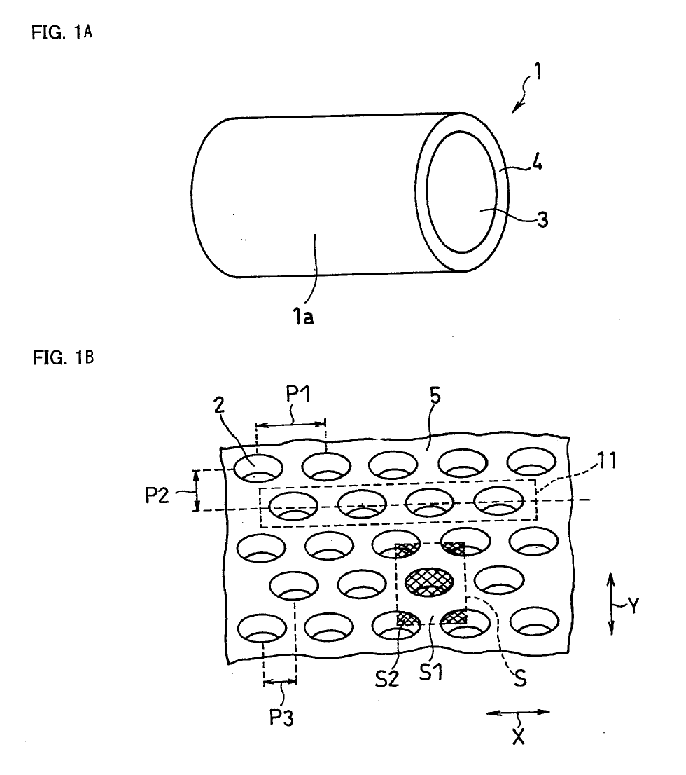

FIG. 1A schematically shows the structure of a roller which is used as a work tool in a method for producing a battery current collector in accordance with Embodiment 1 of the invention. FIG. 1B is a partially enlarged perspective view of the outer surface thereof.

A roller 1 has an outer surface 1a which is used as a work surface, and the outer surface 1a is composed of a large number of depressions 2 and a pressing plane 5 around the depressions 2. The pressing plane 5 is preferably formed so that the surface roughness (hereinafter referred to as arithmetic mean roughness Ra) is 0.8 μm or less. Also, the depressions 2 can be formed so that their depth is 1 to 15 μm. Also, the roller 1 is composed of a core portion 3 and an outer portion 4 which are made of different materials, as will be detailed below. In FIG. 1A, the rotation shafts of the roller 1 at both ends thereof are omitted.

The arrangement pattern of the depressions 2 in the outer surface 1a of the roller 1 is preferably such that all the intervals between the adjacent depressions 2 are equal. If it is such an arrangement, it is not particularly limited.

FIG. 1B shows an example of such arrangement pattern of the depressions 2. In the example shown, in the direction X, which is the axial direction of the roller 1, the depressions 2 are linearly aligned at an equal pitch P1 to form row units 11. In the direction Y, which is the circumferential direction of the roller 1, the row units 11 are aligned at an equal interval that is twice a pitch P2. The respective depressions 2 of the row units 11 adjacent in the direction Y are displaced in the direction X by a pitch P3, which is ½ of the pitch P1, and all the intervals between the adjacent depressions 2 are equal. It should be noted that the pitch P3 by which the depressions 2 of the adjacent row units 11 are displaced in the direction X is not limited to ½ of the pitch P1, and can be set to any given pitch. Also, the shape of opening of each depression 2 is not limited to a substantial circle, and may be a substantial oval, a substantial rectangle, a substantial rhombus, a substantial square, and substantial polygons such as a substantially regular hexagon and a substantially regular octagon.

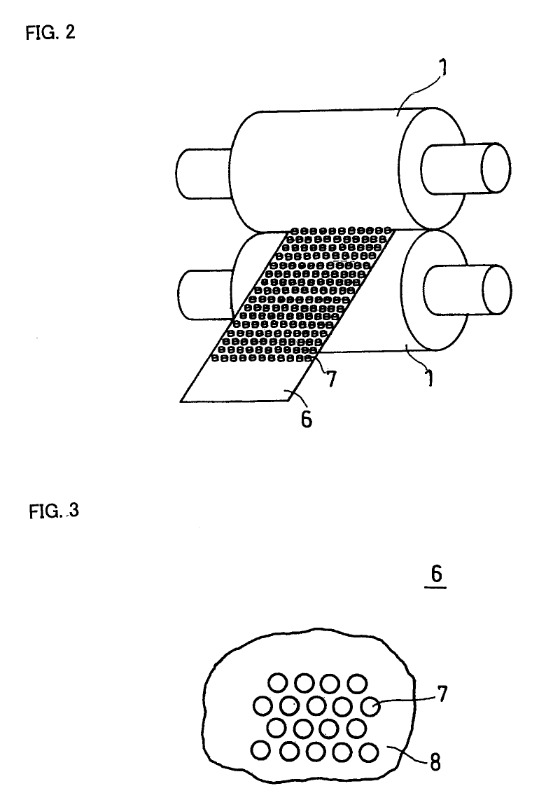

FIG. 2 is a perspective view showing an example of how the roller 1 is used. FIG. 3 is a plan view of a part of a current collector 6 produced by using the rollers 1. In the example shown in FIG. 2, a pair of the rollers 1 with the depressions 2 formed in their outer surfaces 1a in the above-mentioned arrangement pattern is disposed with a predetermined gap between the upper and lower rollers. By passing a metal foil which is the material of the long battery current collector sheet (hereinafter referred to as simply “current collector”) 6 between the two rollers 1, the metal foil is pressed. As a result, protrusions 7 corresponding to the depressions 2 and a base plane 8 corresponding to the pressing plane 5 are formed on both sides of the metal foil. The material of the metal foil 10 can be aluminum, copper, and an alloy thereof.

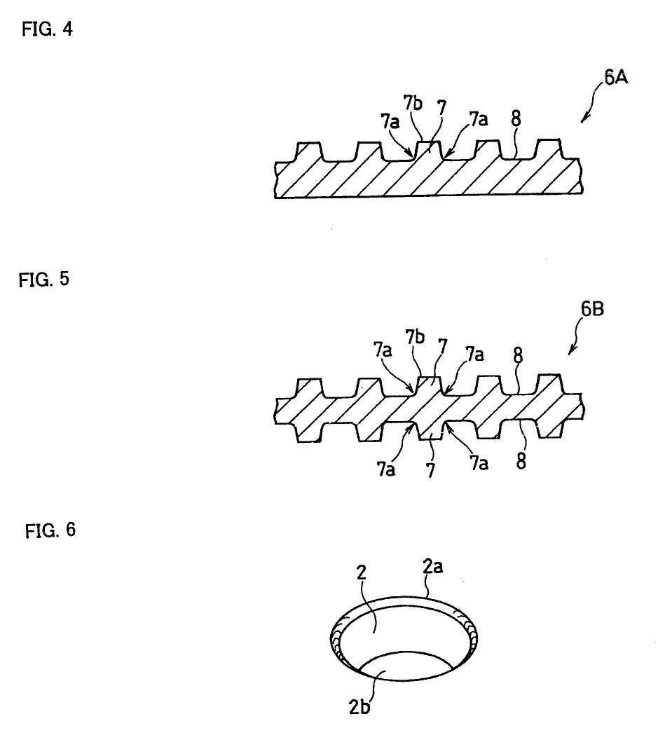

At this time, the protrusions 7 are not pressed by the pressing plane 5 of each roller 1, nor are they pressed by a bottom 2b of each depression 2 (see FIG. 6), as will be described later. Thus, in particular, the surface roughness of a top plane 7b (see FIG. 4) of each protrusion 7 is kept equal to that of the metal foil used as the raw material. Also, as will be described in Examples in details, the base plane 8 is preferably compressed to a surface roughness of 0.8 μm or less by the pressurization of the rollers 1, and the surface roughness of the top plane 7b of each protrusion 7 is preferably greater than that of the base plane 8. It should be noted that one of the two rollers 1 of FIG. 2 may be replaced with a roller whose outer surface 1a is flat, so as to form the protrusions 5 only on one side of the metal foil 4.

FIG. 4 is a transverse sectional view of a current collector. A current collector 6A illustrated therein is a current collector with the protrusions 7 formed on one side thereof. Each protrusion 7 has a slope 7a at the foot thereof, so that the protrusion 7 is gently raised from the base plane 8. FIG. 5 is a transverse sectional view of another current collector. A current collector 6B illustrated therein is a current collector with the protrusions 7 formed on both sides thereof. Each protrusion 7 has the slope 7a where it is raised from the base plane 8, as in the current collector. 6A of FIG. 4.

In correspondence therewith, when the depressions 2 are formed by engraving the outer surface 1a, for example, by laser machining, it is preferable to grind and remove the protruding portions formed on the open edges by using diamond particles or the like.

Using such a method, it is preferable to form a curved portion 2a on the open edge of the depression 2, as illustrated in FIG. 6.

Also, the roller 1 is a solid-core composite roller in which the core portion 3 is fitted inside the outer portion 4 by expansion fit, shrink fit, or mutual diffusion of the interface thereof. The core portion 3 can be made of a quenched alloy composed mainly of iron. The outer portion 4 can be made of ceramics, a super hard alloy, or a quenched alloy composed mainly of iron. It is desirable to use ceramics with a porosity of 5% or less (porosity as used herein refers to the ratio of air holes to the volume of the whole material). It should be noted that when using a roller with an outer diameter of less than 30 mm, it is preferable to use an integrally formed roller composed only of the same material, in order to prevent a significant decrease in transverse rupture strength.

By setting the porosity of the outer portion 4 to 5% or less, it is possible to prevent variations in the shape of the depressions 2 and the area of the pressing plane 5 and therefore variations in the shape and strength of the protrusions 7 formed. This permits a reduction in problems such as warpage and wrinkles of the current collector 6. It is therefore possible to eliminate the causes of problems, such as an internal short-circuit, associated with the non-aqueous secondary battery that is produced using the current collector 6.

In the case of a super hard alloy, the cracking, chipping, abrasion resistance, and tenacity thereof are controlled by the particle size of WC (tungsten carbide) contained therein, the kind of the binder, and the quenching hardness. The particle size of WC is set to 5 μm or less, since good workability can be obtained in forming the depressions 2 of desired shape. The binder is preferably made of Co (cobalt), Ni (nickel), or a mixture thereof, since this can prevent the outer surface 1a of the roller 1 from becoming cracked or chipped while providing good chemical resistance. It is also preferable to set the surface hardness to an HRa (Rockwell A scale hardness) of 82 or more, since this can enhance the abrasion resistance of the roller 1 and expand the life of the roller 1.

Also, the outer surface 1a can be the finished surface of the above-described material without any modification.

Alternatively, the outer surface 1a can be a coating that is formed by CVD, PVD, or thermal spraying of ceramics composed of amorphous carbon, DLC (diamond-like carbon), TiC (titanium carbide), TiN (titanium nitride), or an oxide, nitride, or carbide composed mainly of Zr (zirconium), Si (silicon), Cr (chromium), and Al (aluminum). The coating is performed after the outer surface 1a is subjected to laser machining or the like to form the depressions 2. The thickness of the coating can be set to 1 to 120 μm. The coated outer surface 1a is subjected to a finishing process such that the surface roughness of the pressing plane 5 is 0.8 μm or less.

Next, the process of forming the protrusions 7 on a surface of a metal foil is described.

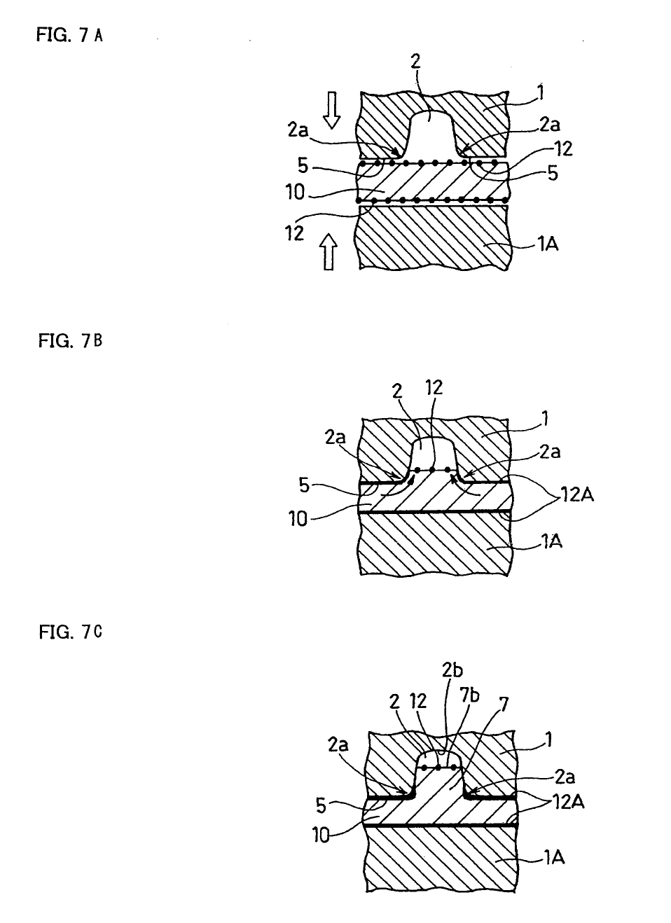

In FIGS. 7A to 7C, a current collector with the protrusions 7 only on one side is produced, using the roller 1 with the depressions 2 as the upper roller of a pair of rollers for pressing a metal foil, and using another roller 1A with a flat work surface as the lower roller.

FIG. 7A schematically illustrates a state immediately before a metal foil 10 with a lubricant 12 applied on both sides thereof is pressed by the roller 1 and the roller 1A.

As the lubricant 12, a solution is prepared by diluting at least one selected from the group consisting of myristic acid, stearic acid, caprylic acid, capric acid, lauric acid, oleic acid, and ether compounds with an organic dispersion medium such as ethanol, methanol, ester, kerosene, light oil, or fatty acid, an aqueous dispersion medium such as pure water, or a surfactant. The solution is evenly applied onto the metal foil 10 and dried to form a film 12A of the lubricant 12 (see FIGS. 7B and 7C), having a thickness of 1 μm or less and comprising the evenly dispersed solid, on each side of the metal foil 10.

FIG. 7B schematically illustrates an initial state of formation of the protrusion 7 on a surface of the metal foil 10 due to pressurization. When a pressure is applied to the metal foil 10 from the upper roller 1, the solid lubricant 12 enters the microscopic recesses and pores in the pressing plane 5, so that the surface roughness of the pressing plane 5 is further reduced. In this state, plastic deformation starts in which part of the metal foil 10 flows in the depth direction of the depression 2 along the curved portion 2a of the edge of the depression 2 in the upper roller 1, as shown by the arrows in the figure.

FIG. 7C schematically illustrates a state in which the plastic deformation of FIG. 7B has proceeded and the formation of the protrusion 7 has been completed. In this state, also, the top plane 7b of the protrusion 7 is not in contact with the bottom 2b of the depression 2, and therefore, the surface roughness of the top plane 7b is kept equal to that of the metal foil 10 as the raw material. Also, due to the effect of the lubricant 12, the coefficient of friction between the metal foil 10 and the upper roller 1 and the lower roller 1A is low, and thus the current collector 6 produced has improved releasability from the two rollers 1 and 1A. It is therefore possible to suppress the occurrence of warpage, wrinkles, etc. of the current collector 6.

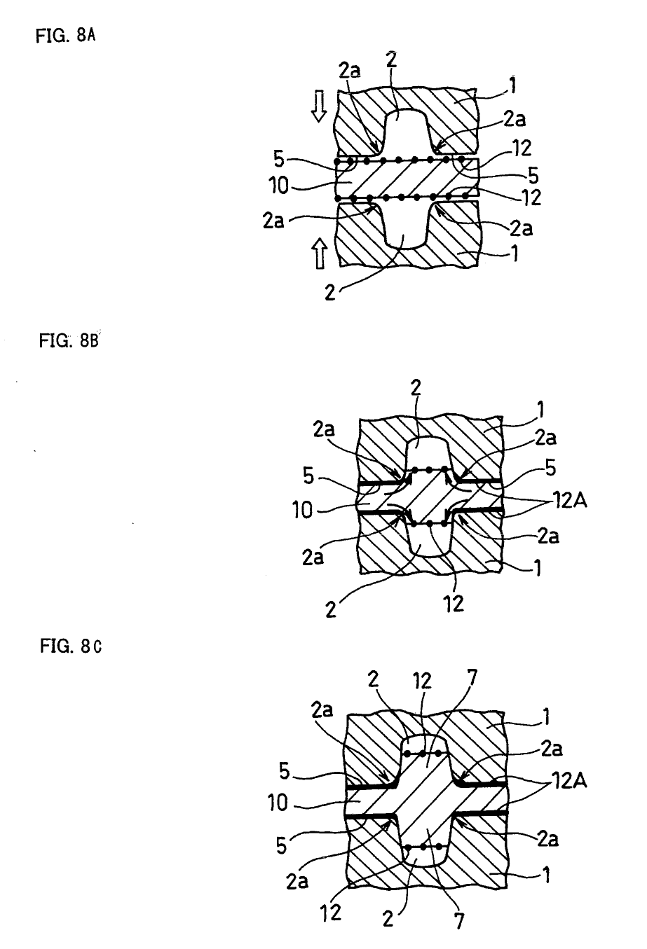

Next, with reference to FIGS. 8A to 8C, an explanation is given of the process of producing a current collector with the protrusions 7 formed on both sides thereof, using two rollers 1 with the depressions 2 as the pair of rollers for pressing the metal foil 10.

FIG. 8A schematically illustrates a state immediately before the metal foil 10 with the solid lubricant 12 applied on both sides thereof is pressed by the pair of rollers 1.

FIG. 8B schematically illustrates an initial state of formation of the protrusions 7 on the surfaces of the metal foil 10 due to pressurization. When a pressure is applied to the metal foil 10 from the upper and lower rollers 1, the solid lubricant 12 enters the microscopic recesses and pores in the pressing planes 5, so that the surface roughness of the pressing planes 5 is further reduced. In this state, plastic deformation starts in which part of the metal foil 10 flows in the depth directions of the depressions 2 along the curved portions 2a of the edges of the depressions 2 in the upper and lower rollers 1, as shown by the arrows in the figure.

FIG. 8C schematically illustrates a state in which the plastic deformation of FIG. 8B has proceeded and the formation of the protrusions 7 has been completed. In this state, also, the top plane 7b of each protrusion 7 is not in contact with the bottom 2b of each depression 2, and therefore, the surface roughness of the top plane 7b is kept equal to that of the metal foil 10 as the raw material. Also, due to the effect of the lubricant 12, the coefficient of friction between the metal foil 10 and the upper and lower rollers 1 is low, and thus the current collector 6 produced has improved releasability from the upper and lower rollers 1. It is therefore possible to suppress the occurrence of warpage, wrinkles, etc. of the current collector 6.

The method of forming the protrusions 7 on the surface(s) of the metal foil 1 is not limited to the method of using rollers. For example, it is possible to form the protrusions 7 by placing the metal foil 10 between upper and lower dies and pressing it.

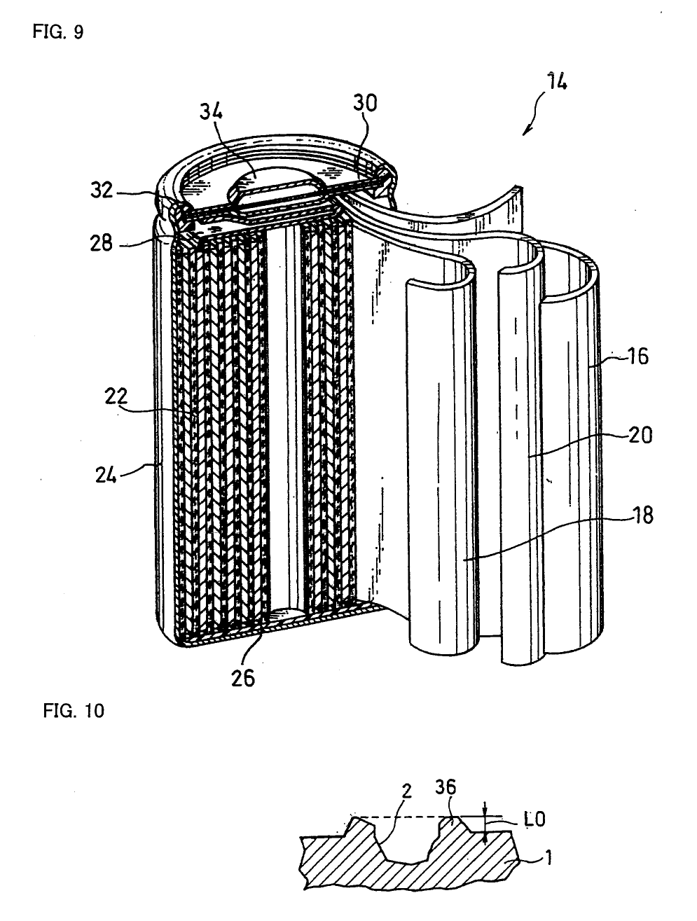

FIG. 9 illustrates an exemplary non-aqueous secondary battery to which a battery current collector of the invention is applied. A battery 14 illustrated therein is a lithium ion secondary battery, and an example of the production process thereof is explained below.

For example, a positive electrode plate 16 using a composite lithium oxide as an active material and a negative electrode plate 18 using a material capable of retaining lithium as an active material are spirally wound, with a separator 20 interposed therebetween, to form an electrode assembly 22.

The electrode assembly 22 is placed in a cylindrical battery case 24 with a bottom. A negative electrode lead 26 drawn from the lower part of the electrode assembly 22 is connected to the bottom of the battery case 24, while a positive electrode lead 28 drawn from the upper part of the electrode assembly 22 is connected to a seal plate 30 with a positive electrode terminal 34. Subsequently, an electrolyte (not shown) comprising a predetermined amount of a non-aqueous solvent is injected into the battery case 24. Thereafter, the seal plate 30 with a gasket 32 attached to the circumference thereof is inserted into the opening of the battery case 24, and the opening of the battery case 24 is bent inward and crimped for sealing.

A common method for disposing an active material on a current collector made of metal foil is a method of applying an electrode mixture paint containing an active material onto a current collector and drying it.

While the positive electrode plate is not particularly limited, an aluminum or aluminum alloy foil is used as a current collector. The thickness thereof can be set to 5 to 30 μm. An active material, a conductive agent, and a binder for the positive electrode are mixed and dispersed in a dispersion medium with a dispersing device such as a planetary mixer to form a positive electrode mixture paint. The paint is then applied onto one or both sides of the foil with a die coater. After the paint is dried, the foil is compressed to a predetermined thickness with a press to obtain a positive electrode plate. The positive electrode plate is usually produced as described above; however, as described later, when an active material is disposed on a current collector of the invention, it is more preferable to dispose the active material by a vacuum process.

Examples of the positive electrode active material which can be used include composite oxides such as lithium cobaltate and modified lithium cobaltate (solid solutions of lithium cobaltate with aluminum or magnesium dissolved therein), lithium nickelate and modified lithium nickelate (in which nickel is partially replaced with cobalt), and lithium manganate and modified lithium manganate.

Examples of the positive electrode conductive agent include carbon blacks such as acetylene black, ketjen black, channel black, furnace black, lamp black, and thermal black, and various graphites, and they can be used singly or in combination of two or more of them.

Examples of the positive electrode binder which can be used include polyvinylidene fluoride (PVdF), modified polyvinylidene fluoride, polytetrafluoroethylene (PTFE), and rubber particle binders having an acrylate unit. It is also possible to use a binder comprising copolymerized acrylate monomers or oligomers with reactive functional groups introduced therein.

While the negative electrode plate is not particularly limited either, a metal foil such as a rolled copper foil or an electrolytic copper foil can be used as the current collector. The thickness thereof can be set to 5 μm to 25 μm. An active material, a binder, and if necessary, a conductive agent and a thickener for the negative electrode are mixed and dispersed in a dispersion medium with a dispersing device such as a planetary mixer, to form a negative electrode mixture paint. The paint is applied onto the foil with a die coater and dried, and the foil is then compressed to a predetermined thickness with a press to obtain a negative electrode plate. The negative electrode plate is usually produced as described above; however, when an active material is disposed on a current collector of the invention, it is more preferable to dispose the active material by a vacuum process, as described later.

Examples of the negative electrode active material which can be used include various natural graphites and artificial graphites, silicon-based composite materials such as silicide, and various alloy composition materials.

Examples of the negative electrode binder which can be used include various binders such as PVdF and modified PVdF. In terms of enhancing lithium ion acceptance, it is also possible to use styrene-butadiene copolymer rubber particles (SBR) and modified SBR.

The negative electrode thickener is not particularly limited if it is a viscous material as an aqueous solution such as polyethylene oxide (PEO) or polyvinyl alcohol (PVA). However, cellulose resins such as carboxymethyl cellulose (CMC) and modified cellulose resins are preferable in terms of enhancing the dispersibility and viscosity of the electrode mixture paint.

The separator interposed between the positive electrode plate and the negative electrode plate is not particularly limited if it has a composition capable of withstanding the use in non-aqueous type secondary batteries. However, it is common and preferable as an embodiment to use one or more microporous films made of olefin resin such as polyethylene or polypropylene singly or in combination. While the thickness of the separator is not particularly limited, it can be set to 10 to 25 μm.

With respect to the electrolyte, various lithium compounds such as LiPF₆ (lithium hexafluorophosphate) and LiBF₄ (lithium tetrafluoroborate) can be used as electrolyte salts. Also, as the solvent, ethylene carbonate (EC), dimethyl carbonate (DMC), diethyl carbonate (DEC), and methyl ethyl carbonate (MEC) can be used singly or in combination. It is also preferable to use vinylene carbonate (VC), cyclohexyl benzene (CHB), modified VC, and modified CHB, in order to provide a good coating film on the positive electrode plate or negative electrode plate, or ensure stability during overcharge.

Also, as the method for disposing an active material on a current collector, it is more preferable to use a vacuum process since it is capable of selectively disposing the active material on a specific area of the current collector. This allows the active material to be disposed mainly on the protrusions 7. At this time, it is more preferable to deposit the active material on each protrusion 7 in columnar shape so as to cover the top plane 7a and side face of the protrusion 7 (see FIG. 13).

The reason is that the top planes 7a of the protrusions 7 are not compressed, and thus maintain the initial surface accuracy without being affected by work strain and the like. This allows the active material to be disposed on the top planes 7a of the protrusions 7 with good accuracy. Further, by laterally connecting the columnar active materials deposited on the protrusions 7 arranged at a predetermined interval to form a thin film, it is possible to expect that when the active materials absorb lithium, the volume expansion of the active material thin film is reduced.

As the vacuum process, a dry process such as deposition, sputtering, or CVD can be used. In the case of using such a vacuum process, the active material, for example, the negative electrode active material, can be a simple substance of Si, Sn (tin), Ge (germanium), or Al, an alloy thereof, an oxide such as SiOₓ or SnOₓ, SiSₓ, SnS, etc. Also, the negative electrode active material is preferably amorphous or low-crystalline.

The thickness of the active material thin film disposed on the protrusions 7 differs by the characteristics required of the non-aqueous secondary battery produced; however, it is preferably about in the range of 5 to 30 μm, and more preferably in the range of 10 to 25 μm.

Examples of the invention according to Embodiment 1 are hereinafter described. It should be noted that the invention is not to be construed as being limited to the following Examples.

### Example 1

The roller used was prepared as follows: the core portion 3 was made of a quenched alloy steel, die steel SKD11, and the outer surface 1a was formed by thermal spraying of a super hard alloy on the outer portion 4. Further, the outer surface of the roller was subjected to laser machining to form the depressions 2 in the arrangement as illustrated in FIG. 1B. Using a plurality of diamond particles with a mean particle size of 0.5 to 30 μm, the outer surface 1a of the roller was ground to remove burrs or protruding portions formed on the edges of the depressions 2. This is to prevent the surface roughness of the outer surface of the roller from partially increasing due to the burrs or protruding portions. In this way, the pressing plane 5, which is the part of the outer surface of the roller excluding the depressions 2, was finished so that the surface roughness (hereinafter arithmetic mean roughness Ra) was 0.8 μm.

The roller with the depressions 2 formed on the outer surface 1a as described above was placed on the upper side, while a roller having a flat outer surface and being made of the same material was placed on the lower side. A metal foil with the solid lubricant 12 applied thereto was sandwiched between the two rollers. The rollers were then rotated to form the protrusions 7 on the metal foil, and at the same time, to form the base plane 8 with a surface roughness of 0.8 μm. In this way, a current collector was produced. The metal foil used was an aluminum alloy foil with a surface roughness of 0.8 μm. The lubricant 12 used was prepared by dissolving and dispersing myristic acid in pure water.

A positive electrode plate was produced by selectively depositing a positive electrode active material on the protrusions 7 of the current collector thus produced by a vacuum process. In order to remove the excessive active material having adhered to the base plane 8 of the current collector in the vacuum process; the current collector was wound in the same manner as in the formation of an electrode assembly and then unwound again, and this operation was repeated three times. After the operation, the weight of the active material adhering to the base plane 8 was measured, and based on the measurement result, the electrode plate was evaluated as to whether it was good or poor.

The electrode plate was evaluated in consideration of the above-mentioned fact that by depositing the active material on the protrusions 7 in columnar shape to form an active material thin film, the volume expansion of the thin film upon lithium absorption can be reduced. More specifically, for example, when the weight of the active material remaining on the base plane 8 of the current collector per 1 cm² is 1 mg or less, desired performance of the non-aqueous electrolyte secondary battery using the electrode plate is maintained even after 300 charge/discharge cycles. Therefore, when the weight of the active material remaining on the base plane 8 per 1 cm² was 1 mg or less, the electrode plate was evaluated as being good, (symbol “∘”), and when the weight of the remaining active material exceeded 1 mg, the electrode plate was evaluated as being poor (symbol “×”).

### Example 2

The pressing plane 5 of the upper roller was finished so that the surface roughness was 0.2 μm. Using this, a positive electrode current collector in which the surface roughness of the base plane 8 was 0.2 μm was produced.

### Example 3

The outer surface of the upper roller was coated with thermally sprayed ceramics. The pressing plane 5 thereof was finished so that the surface roughness was 0.08 μm. Using this roller, a positive electrode current collector in which the surface roughness of the base plane 8 was 0.08 μm was produced.

### Comparative Example 1

The outer surface of the upper roller was formed by nickel plating. The pressing plane 5 thereof was finished so that the surface roughness was 3.2 μm. Using this roller, a positive electrode current collector in which the surface roughness of the base plane 8 was 3.2 μm was produced.

In Examples 2 to 3 and Comparative Example 1, electrode plates were produced and evaluated in the same manner as in Example 1 except for the differences described above. Table 1 shows the above results.

TABLE 1

| | Surface | Surface | | |
|---|---|---|---|---|
| | roughness of | roughness of top | Weight | |
| | base plane | plane of | of active | |
| | (arithmetic | protrusions | material | |
| | mean | (arithmetic mean | remaining on | |
| | roughness Ra) | roughness Ra) | base plane | Eval- |
| | (μm) | (μm) | (mg) | uation |
| Example 1 | 0.8 | 0.8 | 0.98 | ∘ |
| Example 2 | 0.2 | 0.8 | 0.76 | ∘ |
| Example 3 | 0.08 | 0.8 | 0.59 | ∘ |
| Comparative | 3.2 | 0.8 | 162.4 | x |
| Example 1 | | | | |

As is clear from Table 1, in Comparative Example 1 in which the surface roughness of base plane 8 of the current collector is 3.2 μm, the weight of the remaining active material is 162.4 mg, which is exceptionally large. In contrast, in each of Examples 1 to 3 in which the surface roughness of the base plane 8 is 0.8 μm or less, the weight of the remaining active material is 1.0 mg or less. This indicates that by setting the surface roughness of base plane 8 of the current collector to 0.8 μm or less, it is possible to suppress deterioration due to charge/discharge cycles.

Also, when Example 1 in which the surface roughness of the base plane 8 is 0.8 μm is compared with Example 3 in which it is 0.08 μm, their weights of the remaining active material are 0.98 mg and 0.59 mg, respectively, which are very close values. This shows that when the surface roughness of the base plane 8 is 0.8 μm or less, further reducing the surface roughness does not result in a significant reduction in the weight of the remaining active material.

Also, an observation with an electron microscope has confirmed that in Example 1 in which the surface roughness of the base plane 8 is 0.8 μm, the amount of the active material remaining on the base plane 8 is very small, in the same manner as in Example 3 in which the surface roughness of the base plane 8 is 0.08 μm. Therefore, by setting the surface roughness of the base plane 8 to 0.8 μm or less, it is possible to achieve the effect of suppressing deterioration due to charge/discharge cycles. With respect to Comparative Example 1, an observation with an electron microscope has confirmed that almost no active material was removed form the base plane 8 of the current collector.

As described above, it can be understood that in the case of forming protrusions on a metal foil and selectively disposing an active material thereon with a suitable gap therebetween, by making the surface roughness of top plane 7b of the protrusions 7 greater than the surface roughness of the base plane 8, and setting the surface roughness Ra of the base plane 8 to 0.8 μm or less, it is possible to suppress deterioration due to charge/discharge cycles.

Also, in Examples 1 to 3, the outer surface of the upper roller was ground with the diamond particles of 0.5 to 30 μm. In addition, a solid lubricant was applied to the metal foil in advance. As a result, the solid lubricant entered the minute recesses and pores created by the grinding with the diamond particles. Thus, an observation with an electron microscope has confirmed that the surface roughness of base plane 8 of the current collector is less than the surface roughness of pressing plane 5 of the upper roller.

Also, another experiment has confirmed that, in the case of using a roller having an excessively porous, thermal spray film (coating) of ceramics with a porosity of higher than 5%, even the use of a solid lubricant results in limited surface roughness. This is probably because the amount of the solid lubricant particles having entered the pores is insufficient. It has been found that by setting the porosity of the outer surface of the roller to 5% or less and setting the surface roughness (arithmetic mean roughness) of the pressing plane to 3.2 μm or less, the arithmetic mean roughness of base plane of the current collector can be set to 0.2 μm or less.

### Example 4

In the following Examples 4 to 11 and Comparative Examples 2 to 4, the relation between the roller life and the hardness and particle size of the super hard alloy covering the roller surface is examined.

In Examples 4 to 11 and Comparative Examples 2 to 4, a metal foil serving as the material of a current collector was also compressed by a pair of rollers arranged vertically, as illustrated in FIG. 2. Of each of the upper and lower rollers, the outer surface 1a was composed of a super hard alloy with an HRa of 89 which was prepared by sintering WC with a particle size of 3±1 μm with Co (cobalt) as a binder and coating it with diamond-like carbon of 0.5 μm by PVD. These rollers were provided with the depressions 2 in the arrangement as illustrated in FIG. 1B by laser machining, and the surface roughness of the pressing plane 5 excluding the depressions 2 was set to 0.8 μm.

Also, a solid lubricant was disposed onto the surfaces of the metal foil serving as the material of the current collector in advance. The solid lubricant was disposed by diluting an agent with a solvent, applying it onto the surfaces of the metal foil, and drying it. With respect to the amount applied, the weight of the agent was 3.3 g/m². Also, the pressure applied by the rollers was set to a linear pressure of 100 KN/cm, and the metal foil with a whole length of 1000 m was continuously pressed.

Except for these, in the same manner as in Example 1, a current collector was produced. Then, the surface roughness of base plane 8 of the current collector, the height of the protrusions 7 from the base plane 8, the warpage of the current collector as a measure of releasability, and the amount of decrease of the depth of the depressions 2 in the roller as a measure of roller life were measured to evaluate releasability and roller life.

The evaluation was made in consideration of the quality of the produced current collector and mass productivity. Specifically, when the warpage of the current collector was 2 mm or less, the amount of decrease of the depth of the depressions 2 in the roller due to the continuous compression of the 1000-m long metal foil at the linear pressure of 100 KN/cm was 0.1 μm or less, and the height of the protrusions 7 from the base plane 8 of the current collector was 5 μm or more, such cases were evaluated as being good (symbol “∘”). The other cases were evaluated as being poor (symbol “×”). As used herein, “warpage” refers to a lateral curve of a current collector placed on a flat plane. For the measurement thereof, a ruler was placed along a side of a current collector with a length of 800 mm and a width of 80 mm, and the largest distance of the gap between the ruler and the side face of the current collector at the midpoint was measured.

### Example 5

Stearic acid was dissolved and dispersed in ethanol, and the dispersion was volatilized to obtain a solid lubricant. The solid lubricant was disposed on a metal foil which was the material of a current collector. The surface roughness of pressing plane of the upper and lower rollers was set to 0.4 μm. The outer portion 4 of each of the rollers was composed of a super hard alloy comprising WC (particle size: 2±1 μm) with Co as a binder and having an HRa of 90, and the surface thereof was coated with 0.5-μm thick amorphous carbon by CVD.

### Example 6

Caprylic acid was dissolved and dispersed in a surfactant, and the dispersion was dried to obtain a solid lubricant. The solid lubricant was disposed on a metal foil which was the material of a current collector. The surface roughness of pressing plane of the upper and lower rollers was set to 0.2 μm. The outer portion of each of the rollers was composed of a super hard alloy comprising WC (particle size: 1.5±1 μm) with Ni as a binder and having an HRa of 91, and the surface thereof was coated with 120-μm thick ceramics (Cr₂O₃) by thermal spraying.

### Example 7

Myristic acid was dissolved and dispersed in pure water, and the dispersion was dried to obtain a solid lubricant. The solid lubricant was disposed on a metal foil which was the material of a current collector. The surface roughness of pressing plane of the upper and lower rollers was set to 0.8 μm. The outer portion 4 of each of the rollers was composed of a quenched alloy composed mainly of iron and having an HRa of 82, and the surface thereof was finished by cylindrical grinding.

### Example 8

Caprylic acid was dissolved and dispersed in ethanol, and the dispersion was dried to obtain a solid lubricant. The solid lubricant was disposed on a metal foil which was the material of a current collector. The surface roughness of pressing plane 5 of the upper and lower rollers was set to 0.8 μm. The outer portion 4 of each of the rollers was composed of a super hard alloy comprising WC (particle size: 3±1 μm) with Co as a binder and having an HRa of 89, and the surface thereof was provided with a 120-μm thick coating by forming TiC and TiN multi-layers and a TiCN intermediate layer by CVD.

### Example 9

Lauric acid was dissolved and dispersed in methanol, and the dispersion was dried to obtain a solid lubricant. The solid lubricant was disposed on a metal foil which was the material of a current collector. The surface roughness of pressing plane 5 of the upper and lower rollers was set to 0.8 μm. The outer portion 4 of each of the rollers was composed of a super hard alloy comprising WC (particle size: 3±1 μm) with Co as a binder and having an HRa of 89, and the surface thereof was provided with a 120-μm thick coating by thermal spraying of ceramics (Cr₂O₃).

### Example 10

Lauric acid was dissolved and dispersed in methanol, and the dispersion was dried to obtain a solid lubricant. The solid lubricant was disposed on a metal foil which was the material of a current collector. The surface roughness of pressing plane 5 of the upper and lower rollers was set to 0.8 μm. The outer portion 4 of each of the rollers was composed of a super hard alloy comprising WC (particle size: 3±1 μm) with Co as a binder and having an HRa of 89, and the surface thereof was provided with a 120-μm thick coating by thermal spraying of ceramics (Si₃N₄).

### Example 11

Lauric acid was dissolved and dispersed in methanol, and the dispersion was dried to obtain a solid lubricant. The solid lubricant was disposed on a metal foil which was the material of a current collector. The surface roughness of pressing plane 5 of the upper and lower rollers was set to 0.8 μm. The outer portion 4 of each of the rollers was composed of a super hard alloy comprising WC (particle size: 3±1 μm) with Co as a binder and having an HRa of 89, and the surface thereof was provided with a 120-μm thick coating by thermal spraying of ceramics (Al₂O₃).

### Comparative Example 2

A solid lubricant was not disposed on a metal foil which was the material of a current collector. The surface roughness of pressing plane of each of the upper and lower rollers was set to 1.2 μm. The outer portion of each of the rollers was composed of a high speed tool steel with an HRa of 82, and the surface thereof was finished by cylindrical grinding.

### Comparative Example 3

Lauric acid was dissolved and dispersed in a surfactant to obtain a highly viscous lubricant in a half-dissolved state in which the solid and the liquid are present. The lubricant was applied onto a metal foil which was the material of a current collector. The surface roughness of pressing plane of the upper and lower rollers was set to 1.2 μm. The outer portion of each of the rollers was composed of a super hard alloy comprising WC (particle size: 3±1 μm) with Co as a binder and having an HRa of 89, and the surface thereof was provided with a 12-μm thick coating by forming TiC and TiN multi-layers and a TiCN intermediate layer by CVD.

### Comparative Example 4

Capric acid was dissolved and dispersed in methanol to obtain a liquid lubricant. The liquid lubricant was applied onto a metal foil which was the material of a current collector. The surface roughness of pressing plane of the upper and lower rollers was set to 1.2 μm. The outer portion of each of the rollers was composed of a super hard alloy comprising WC (particle size: 7±1 μm) with Ni as a binder and having an HRa of 82, and the surface thereof was provided with a 120-μm thick coating by thermal spraying of ceramics (Al₂O₃).

### Comparative Example 5

Myristic acid was dissolved and dispersed in ethanol to obtain a liquid lubricant. The liquid lubricant was applied onto a metal foil which was the material of a current collector. The surface roughness of pressing plane of the upper and lower rollers was set to 0.8 μm. The outer portion of each of the rollers was composed of a quenched carbon steel with a particle size of 35 μm and an HRa of 65.

In the foregoing Examples 5 to 11 and Comparative Examples 2 to 5, the current collectors were produced in the same manner as in Example 4 except for the differences as described above, and evaluated in the same manner as in Example 4. Table 2 shows the above results.

TABLE 2

| | | Surface | | | | | |
|---|---|---|---|---|---|---|---|
| | | roughness of | Surface | | | | |
| | | pressing | roughness of | | | | |
| | | plane | base plane | | Amount of | | |
| | | (arithmetic | (arithmetic | | decrease of | Height | |
| | | mean | mean | | depth of | of | |
| | State of | roughness | roughness | Warpage | depressions | protrusions | |
| | lubricant | Ra) (μm) | Ra) (μm) | (mm) | (μm) | (μm) | Evaluation |
| Example 4 | Solid | 0.8 | 0.15 | 1.9 | 0.01 | 7.1 | ∘ |
| Example 5 | Solid | 0.4 | 0.12 | 1.8 | 0.01 | 6.8 | ∘ |
| Example 6 | Solid | 0.2 | 0.1 | 1.2 | 0.01 | 6.9 | ∘ |
| Example 7 | Solid | 0.8 | 0.18 | 1.9 | 0.09 | 6.4 | ∘ |
| Example 8 | Solid | 0.8 | 0.1 | 1.1 | 0.01 | 6.1 | ∘ |
| Example 9 | Solid | 0.8 | 0.1 | 1.2 | 0.02 | 6.2 | ∘ |
| Example 10 | Solid | 0.8 | 0.1 | 1.1 | 0.01 | 6.1 | ∘ |
| Example 11 | Solid | 0.8 | 0.1 | 1.3 | 0.01 | 6.2 | ∘ |
| Comparative | None | 0.8 | 0.9 | 11 | 0.01 | 7.1 | x |
| Example 2 | | | | | | | |
| Comparative | Half- | 0.7 | 0.8 | 3.5 | 0.02 | 3.0 | x |
| Example 3 | dissolved | | | | | | |
| Comparative | Liquid | 0.8 | 0.9 | 11 | 0.01 | 2.1 | x |
| Example 4 | | | | | | | |
| Comparative | Liquid | 0.8 | 0.7 | 8 | 0.2 | 2.0 | x |
| Example 5 | | | | | | | |

As is clear from Table 2, a decrease in the surface roughness of pressing plane 5 of the roller also results in a decrease in the surface roughness of base plane 8 of the current collector when the other conditions are the same. When a solid lubricant was used (Examples 4 to 11), the surface roughness of base plane 8 of the current collector is significantly smaller than the surface roughness of pressing plane 5 of the roller. Contrary to this, when no solid lubricant was used (Comparative Examples 2 to 5), the surface roughness of base plane 8 of the current collector is greater than the surface roughness of pressing plane 5 of the roller. This indicates that the use of a solid lubricant improves the factors relating to the surface roughness of base plane of the current collector.

Also, the warpage of the current collector is related to the releasability of the current collector from the upper and lower rollers. In Comparative Examples 2 to 4 in which no solid lubricant was used, relatively large warpage of 11 mm or 3.5 mm occurred. As a result, the metal foil passing between the upper and lower rollers was not transported stably, and the metal foil became broken etc., and could not be continuously worked. As such, Comparative Examples 2 to 4 were evaluated as being poor (symbol “×”). Contrary to this, in Examples 4 to 11 in which a solid lubricant was disposed, the warpage was as small as 2 mm or less.

Also, it has been found that the amount of decrease of the depth of the depressions 2 in the roller after the continuous pressurization of the 1000-m metal foil at the linear pressure of 100 KN/cm is reduced by the application of a lubricant, regardless of whether it is liquid or solid.

Also, in Comparative Example 5 in which the outer portion of the roller is composed of the quenched carbon steel with an HRa of 65, the amount of decrease of the depth of the depressions was 0.2 μm. Also, since the hardness is low, the diameter of the depressions decreased due to plastic deformation. Hence, the pressing area increased, and the pressing force also decreased gradually. In addition, the height of the protrusions decreased as the process was continued. In Comparative Examples 3 and 4 in which the half-dissolved lubricant or liquid lubricant was applied, the height of the protrusions 7 was only 3 μm or 2.1 μm. Therefore, they were evaluated as being poor (symbol “×”) since the height of the protrusions 7 formed is insufficient. The reason why the height of the protrusions 7 formed is insufficient is probably that the formation of the protrusions was hindered by the liquid pressure of the half-dissolved or liquid lubricant in the depressions 2 of the outer surface la of the roller.

From the above, it can be understood that when using a roller in which the surface roughness of the pressing plane 5 excluding the depressions 2 is approximately 0.8 μm, the use of a solid lubricant is necessary in order to make the surface roughness of the base plane 8 excluding the protrusions 0.8 μm or less and make the warpage 2 mm or less. It can also be understood that when using a roller that has been subjected to a surface treatment so as to make the surface roughness of the pressing plane 5 approximately 0.8 μm for continuously performing a compression process, the use of some kind of lubricant is necessary in order to make the amount of decrease of the depth of the depressions 2 in the roller 0.1 μm or less. It can also be understood that the use of a solid lubricant is necessary to set the height of the protrusions from the base plane 8 to 5 μm or more.

### Example 12

In the following Examples 12 to 14 and Comparative Example 5, the relation between the roller life and the hardness and particle size of the super hard alloy covering the roller surface is examined.

In Examples 12 to 14 and Comparative Example 5, a metal foil serving as the material of a current collector was also compressed by a pair of rollers arranged vertically, as illustrated in FIG. 2. Of each of the upper and lower rollers, the outer surface 1a was composed of a super hard alloy with an HRa of 89 which was prepared by sintering WC with a particle size of 3±1 μm with Co (cobalt) as a binder and coating it with diamond-like carbon of 0.5 μm by PVD. These rollers were provided with the depressions 2 in the arrangement as illustrated in FIG. 1B by laser machining, and the surface roughness of the pressing plane 5 excluding the depressions 2 was set to 0.8 μm.

Also, a solid lubricant was disposed on the surfaces of the metal foil serving as the material of the current collector in advance. The solid lubricant was disposed by diluting an agent with a solvent, applying it onto the surfaces of the metal foil, and drying it. With respect to the amount applied, the weight of the agent was 3.3 g/m².

A copper alloy foil with a maximum zirconium content of 0.03% by weight was used as the metal foil serving as the material of the current collector. The surface roughness was set to 0.8 μm. It was pressed by the rollers to form the protrusions 7 on the surface. An active material was selectively disposed on the protrusions 7 by a vacuum process, to produce a negative electrode plate. The active material used was a material capable of retaining at least lithium.

Also, a positive electrode plate was produced by dispersing an active material comprising a lithium-containing composite oxide, a conductive agent, and a binder in a dispersion medium, kneading them to form a positive electrode mixture paint, and applying the paint onto a positive electrode current collector. Using the negative electrode plate and the positive electrode plate, a cylindrical lithium ion secondary battery (hereinafter referred to as a test battery) was produced as illustrated in FIG. 9.

The test battery produced was discharged from a 100% state of charge to a 40% state of charge, and such charge/discharge was repeated to examine the cycle characteristics thereof. The battery life was evaluated based on the number of cycles at which the battery capacity decreased to less than 75% of the initial state.

More specifically, when this number of cycles was 300 cycles or more, it was evaluated as being good (symbol “∘”), and when it was less than 300 cycles, it was evaluated as being poor (symbol “∘”).

### Example 13

A test battery was produced in the same manner as in Example 12, except for the use of a current collector whose base plane 8 had a surface roughness of 0.4 μm as the negative electrode plate, and the life of the battery was evaluated.

### Example 14

A test battery was produced in the same manner as in Example 12, except for the use of a current collector whose base plane 8 had a surface roughness of 0.2 μm as the negative electrode plate, and the life of the battery was evaluated.

### Comparative Example 6

A test battery was produced in the same manner as in Example 12, except for the use of a current collector whose base plane 8 had a surface roughness of 1.6 μm as the negative electrode plate, and the life of the battery was evaluated.

Table 3 shows the above results.

TABLE 3

| | Surface roughness of | | |
|---|---|---|---|
| | base plane | | |
| | (arithmetic mean | Number of | |
| | roughness Ra)(μm) | cycles | Evaluation |
| Example 12 | 0.8 | 301 | ∘ |
| Example 13 | 0.4 | 305 | ∘ |
| Example 14 | 0.2 | 312 | ∘ |
| Comparative Example 6 | 1.6 | 102 | x |

As is clear from Table 3, in Examples 12 to 13 in which the surface roughness of the base plane 8 of the current collector is 0.8 μm or less, the life lasts more than 300 cycles. Contrary to this, in Comparative Example 5 in which the surface roughness of the base plane 8 of the current collector is 1.6 μm, the life ends at the 102^{nd} cycle. Comparative Example 5 was thus evaluated as being poor (symbol “×”).

It should be noted that an observation of the negative electrode plates with an electron microscope has confirmed that by making the surface roughness of the top plane 7b of each protrusion 7 greater than the surface roughness of the base plane 8, the active material can be selectively disposed on the protrusions 7 in a more reliable manner.

### Embodiment 2

Referring to drawings, Embodiment 2 of the invention is described. Embodiment 2 is a modification of Embodiment 1, and the same reference characters as those of Embodiment 1 are used in the following description.

The roller 1 has the depressions 2 with a depth of 1 to 15 μm in the outer surface la, which is the work surface. The outer surface 1a of the roller 1 may be provided with a coating layer containing a super hard alloy or a powder high speed steel (sintered high speed tool steel). The formation of the coating layer further increases the surface hardness of the finally obtained roller 1, thereby suppressing variations in the shape of the protrusions 7.

Also, the roller 1 is heated to 50 to 120° C. by a heat source installed in the roller 1. Since the roller 1 is heated to such temperature, the dispersion of the solid lubricant 12 is promoted. This allows the lubricant 12 whose thickness is on the order of nanometers to be attached to the work surface of the roller 1 more uniformly. As a result, the releasability of the roller 1 from the current collector 6 can be further improved.

Also, the outer surface 1a of the roller 1 may be provided with a coating layer containing a super hard alloy or chromium oxide. Such a coating layer has the effect of reducing resistance such as friction or stress when pressed. Therefore, the use of the roller 1 with such a coating layer reduces the resistance occurring between the roller 1 and the metal foil during the compression process, consequently improving the releasability of the metal foil 10 from the roller 1 after the compression process. This permits easy process control and reduces the defect rate. It should be noted that since such a coating layer is bonded firmly, it is highly unlikely to separate even when used repeatedly. This permits easy process control.

Also, the surface of the coating layer containing a super hard alloy or chromium oxide may be provided with a protective layer containing an amorphous carbon material. This further increases the surface hardness of the finally obtained roller 1, and further promotes the reduction of the resistance occurring between the roller 1 and the metal foil 10 during the compression process and the improvement of the releasability of the metal foil 10 from the roller 1 after the compression process.

Further, the outer surface 1a of the roller 1 may be provided with a coating layer comprising ceramics such as tungsten carbide (WC) or titanium nitride (TiN). This can increase the surface hardness of the finally obtained roller 1, thereby suppressing variations in the shape of the protrusions 7.

In the invention, the above-mentioned various coating or protective layers may be provided with the depressions 2.

The depressions 2 can be formed by, for example, etching, sandblasting, electrical discharge machining, and laser machining. Among them, laser machining is preferable. Laser machining allows minute depressions 2 of 1 to 15 μm to be formed accurately. Examples of lasers used for laser machining include a carbonic acid gas laser, a YAG laser, a YVO4 laser, and an excimer laser. Among them, a YAG laser and a YVO4 laser are preferable since they can control the wavelength of the laser beam in various manners.

The formation of the depressions 2 by laser machining is carried out by irradiating the outer surface la of the roller 1 with a laser beam to instantaneously heat the laser-beam irradiated portion to a high temperature, thereby sublimating that portion. At this time, as illustrated in FIG. 10, the sublimated material of the outer surface 1a of the roller 1 re-adheres to the open edge of the depression 2 to form a burr 36 with a height L0 (height from the outer surface 1a of the roller) of 0.5 to 3.0 μm.

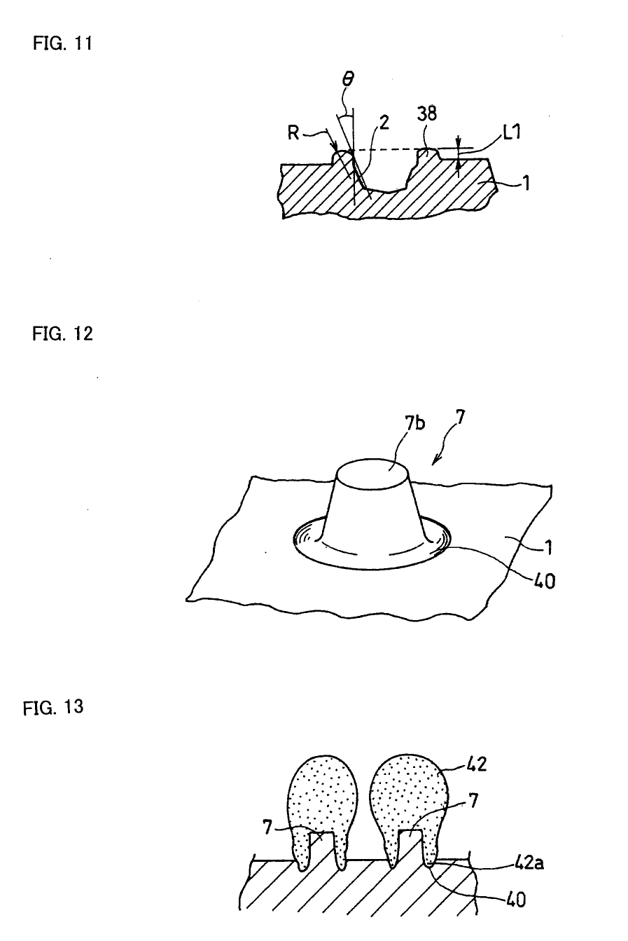

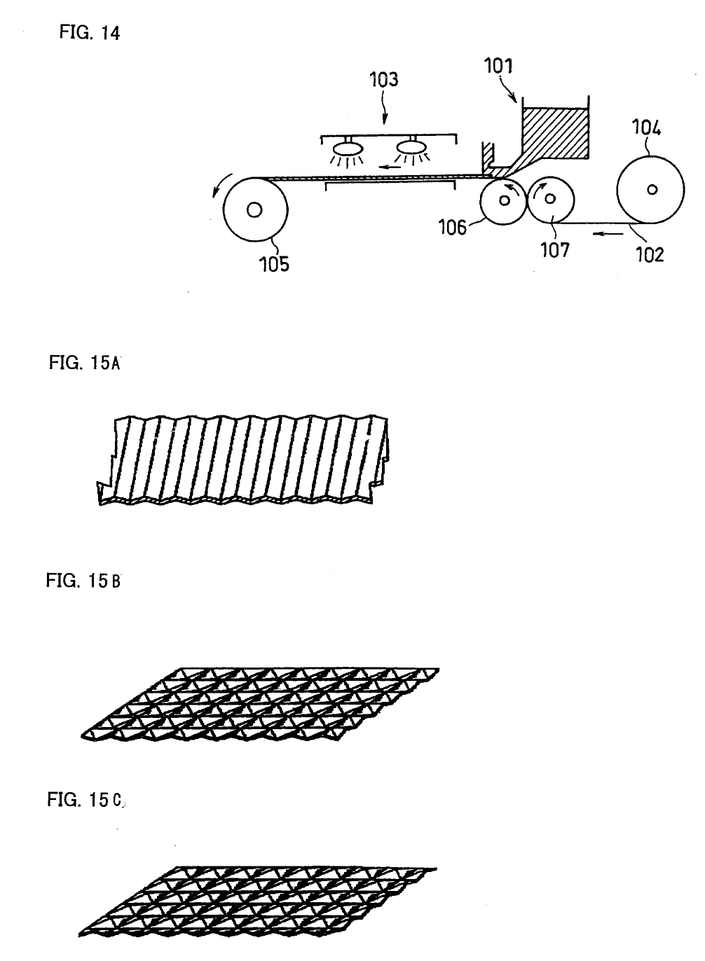

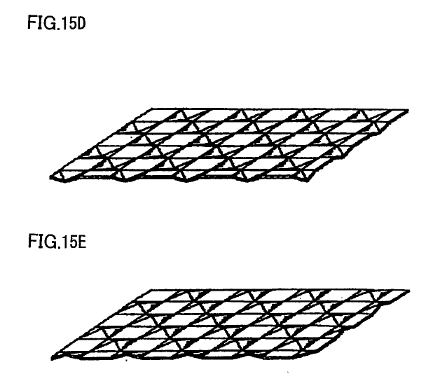

In this embodiment, as illustrated in FIG. 11, the burr 36 is formed so that the height L1 (height from the outer surface 1a of the roller) is in a predetermined range, for example, 0.08 to 0.3 μm. In this way, a bump 38 is formed on the open edge of the depression 2.

FIG. 12 illustrates the protrusion 7 that is formed on a metal foil using the roller 1 having the bump 38. As illustrated in this figure, an indentation 40 corresponding to the bump 38 is formed at the foot of the protrusion 7.

The reason why the height L1 of the bump 38 is set to the above-mentioned range is that if the height L1 exceeds 0.3 μm, the bump 38 tends to undesirably adhere to the metal foil 10 when the roller 1 presses the metal foil 10 to form the protrusions 7. In the event of the adhesion between the bump 38 and the metal foil 10, when they are pulled apart, the metal foil 10 becomes deformed, thereby resulting in wrinkles, warpage, etc. of the metal foil 10. This causes problems. For example, after the process, the metal foil 10 tears before the metal foil 10 is rewound into a roll, or the life of the hoop (reel) for rewinding is shortened.

Also, when the degree of the adhesion is high, the portion of the metal foil 10 adhering to the bump 38 is torn off, and the broken pieces adhere to the outer surface 1a of the roller 1. When the process is continued using the roller 1 with the broken pieces of the metal foil 10 adhering to the outer surface 1a, the portion to which the broken pieces adhere cannot correctly form the protrusions 7. It thus becomes necessary to perform the maintenance of the roller 1 at a short cycle, thereby resulting in low productivity.

On the other hand, if the height L1 of the bump 38 is less than 0.08 μm, the area around the protrusion 7 formed on the metal foil 10 is too flat, and thus the active material adhering to the surface of the current collector 6 is subject to separation. As a result, for example, the separated active material causes a short-circuit, thereby resulting in a problem such as decreased battery performance.

More specifically, as illustrated in FIG. 13, it is preferable that an active material 42 be deposited in columnar shape on the protrusions 7 on the surface of the current collector 6. At this time, when the indentation 40 with a suitable depth is present around each protrusion 7, the active material 9 is also filled into the indentation 40, and a portion 42a of the active material 42 filled into the indentation 40 functions as an anchor. As a result, the active material 42 is unlikely to separate from the surface of the current collector 6.

As shown in FIG. 1, it is preferable to set the ratio ΔS of the area (S1) of the pressing plane 5 on the outer surface 1a (work surface) of the roller 1 to the area (S2, the crosshatched area in the region S in FIG. 1B of openings of the depressions 2 to 0.05 to 0.85 (ΔS=S1/S2, hereinafter referred to as the area ratio: pressing plane/openings of depressions).

The formation of the bumps 38 is preferably performed by grinding with a diamond compound. It is preferable to use a diamond compound that is larger than the smallest size of the depressions 2. More preferably, the mean particle size of the diamond compound is 30 μm or more and less than 35 μm. As used herein, the size of the depressions 2 refers to the diameter of openings of the depressions 2 in the outer surface 1a of the roller 1. The use of a diamond compound with such a mean particle size allows the top faces of the bumps 38 to be curved with a large curvature radius, thereby preventing the adhesion between the bumps 38 and the metal foil 10 more effectively. It also prevents the diamond compound from entering the depressions 2. The curvature radius R of top face of each bump 38 (see FIG. 11) is preferably set to 15 μm or less.

The grinding with a diamond compound can be performed in the same manner as common grinding methods, except for the use of a diamond compound as the abrasive particles or grinding particles. It is usually performed by a grinding machine having a grinding pad, with a diamond compound placed on a surface to be ground, and while supplying a medium such as water.

Also, a cross-section of each depression 2 perpendicular to the outer surface 1a of the roller preferably has a taper so that the width of the cross-section parallel to the outer surface 1a of the roller 1 gradually decreases from the outer surface 1a of the roller 1 to the bottom of the depression 2. This improves the releasability of the current collector 1 from the roller 1 after the completion of the compression process. The angle θ of the taper (see FIG. 11) is preferably set to 5° or more and 60° or less.

The outer surface 1a of the roller 1 and the surface of each depression 2 facing the inner space may be provided with one or more of a coating layer containing a super hard alloy, a coating layer containing an alloy tool steel, a coating layer containing chromium oxide, and a protective layer containing an amorphous carbon material. This can produce essentially the same effects as those obtained by providing the roller 1 with these coating and protective layers. Also, by forming these coating and protective layers by the methods such as physical vapor deposition and chemical vapor deposition, essentially the same effects can be obtained. According to these vapor deposition methods, coating and protective layers can also be formed evenly on the surfaces of the depressions 2 facing the inner space. Also, materials such as a super hard alloy contain cobalt as the binder. When the metal foil 10 contains copper, since the affinity between cobalt and copper is high, it is effective for preventing copper from adhering to the outer surface 1a of the roller 1 or the inner surfaces of the depressions 2.

Also, the outer surface 1a of the roller 1 and the surfaces of the depressions 2 facing the inner space may be provided with a coating layer comprising ceramics such as tungsten carbide (WC) or titanium nitride (TiN). This increases the surface hardness of the roller 1 and significantly reduces the variations in the shape of the protrusions 7 due to plastic deformation caused by the compression process.

Also, while the pressure by which the rollers 1 are pressed against each other is not particularly limited, it is preferably approximately 8 kN to 15 kN per 1 cm of the metal foil.

### Example 15

Examples according to Embodiment 2 are hereinafter described. In these examples, the relation between battery performance and the depth of the depressions 2, the height of the bumps 38, the area ratio: pressing plane/openings of depressions and the like was examined.

A W—Co super hard alloy roller available from Fuji Die Co., Ltd. was used as the roller for forming the depressions 2. The roller width was 100 mm, and the roller diameter was 50 mm. This roller was subjected to laser machining to form the depressions 2 in the arrangement in the foregoing Embodiment. As the laser oscillator, an Nd:YAG second harmonic laser (wavelength 532 nm, pulse width approximately 50 ns) available from Spectra-Physics KK was used. The greatest height of the burrs formed on the open edges of the depressions 2 was approximately 3 μm.

The outer surface 1a of the roller with the depressions 2 formed therein was ground. At this time, a hoop-like polyethylene sheet with a diamond paste attached thereto was brought into contact with the outer surface 1a of the roller, while the sheet was pressed by a steel support plate. In this state, the roller was rotated. As the diamond paste, a diamond compound with a particle size of 6 μm or less was used. The outer surface 1a of the roller was observed with a microscope. As a result, the depressions 2 formed were in the shape of a substantial rhombus, with the average minor axis diameter of 10 openings being 11.0 μm and the average major axis diameter thereof being 20.8 μm. Their depth was 9.3 μm. Also, the opening edges of the depressions 2 had the bumps 38 with a height of 0.28 μm from the work surface. The area ratio (ΔS): pressing plane/openings of depressions was 0.65.

Using such rollers, a metal foil serving as the material of a current collector was pressed to form the protrusions 7. The presence or absence of adhesion of the metal foil to the roller, and the presence or absence of wrinkles/warpage of the current collector made from the metal foil and of tear starting from wrinkles/warpage were checked. Also, an active material was disposed on both front and back sides of the current collector, and a cylindrical secondary battery was produced. At this time, the presence or absence of separation of the active material was checked.

### Example 16

The depressions 2 were formed in a roller made of the same material as that used in Example 15 in the same manner as in Example 15, but only the degree of grinding of the outer surface 1a was changed. As a result, the bumps 38 on the open edges of the depressions 2 had a height of 0.1 μm from the work surface, although the shape and dimensions of the depressions 2 and the area ratio: pressing plane/openings of depressions were almost the same as those in Example 15.

Using such rollers, a metal foil serving as the material of a current collector was pressed to form the protrusions 7, and the presence or absence of adhesion of the metal foil to the roller was checked. Also, the presence or absence of wrinkles/warpage of the current collector made from the metal foil and of tear starting from wrinkles/warpage was checked. Also, an active material was disposed on both front and back sides of the current collector, and a cylindrical secondary battery was produced. At this time, the presence or absence of separation of the active material was checked.

### Example 17

The depressions 2 were formed in a roller made of the same material as that used in Example 15 in the same manner as in Example 15, but only the degree of grinding of the outer surface 1a was changed. As a result, the bumps 38 on the open edges of the depressions 2 had a height of 0.08 μm from the work surface, although the shape and dimensions of the depressions 2 and the area ratio: pressing plane/openings of depressions were almost the same as those in Example 15.

Using such rollers, a metal foil serving as the material of a current collector was pressed to form the protrusions 7, and the presence or absence of adhesion of the metal foil to the roller was checked. Also, the presence or absence of wrinkles/warpage of the current collector made from the metal foil and of tear starting from wrinkles/warpage was checked. Also, an active material was disposed on both front and back sides of the current collector, and a cylindrical secondary battery was produced. At this time, the presence or absence of adhesion of the active material was checked.

### Comparative Example 7

The depressions 2 were formed in a roller made of the same material as that used in Example 15 in the same manner as in Example 15, but only the degree of grinding of the outer surface 1a was changed. As a result, the bumps 38 on the open edges of the depressions 2 had a height of 2.0 μm from the work surface, although the shape and dimensions of the depressions 2 and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of wrinkles/warpage of the current collector made from the metal foil and of tear starting from wrinkles/warpage was checked. Also, an active material was disposed on both front and back sides of the current collector, and a cylindrical secondary battery was produced. At this time, the presence or absence of separation of the active material was checked.

### Comparative Example 8

The depressions 2 were formed in a roller made of the same material as that used in Example 15 in the same manner as in Example 15, but only the degree of grinding of the outer surface 1a was changed. As a result, the bumps 38 on the open edges of the depressions 2 had a height of 1.0 μm from the work surface, although the shape and dimensions of the depressions 2 and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of wrinkles/warpage of the current collector made from the metal foil and of tear starting from wrinkles/warpage was checked. Also, an active material was disposed on both front and back sides of the current collector, and a cylindrical secondary battery was produced. At this time, the presence or absence of separation of the active material was checked. cl Comparative Example 9

The depressions 2 were formed in a roller made of the same material as that used in Example 15 in the same manner as in Example 15, but only the degree of grinding of the outer surface 1a was changed. As a result, the bumps 38 on the open edges of the depressions 2 had a height of 0.5 μm from the work surface, although the shape and dimensions of the depressions 2 and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of wrinkles/warpage of the current collector made from the metal foil and of tear starting from wrinkles/warpage was checked. Also, an active material was disposed on both front and back sides of the current collector, and a cylindrical secondary battery was produced. At this time, the presence or absence of separation of the active material was checked.

### Comparative Example 10

The depressions 2 were formed in a roller made of the same material as that used in Example 15 in the same manner as in Example 15, but only the degree of grinding of the outer surface 1a was changed. As a result, the bumps 38 on the open edges of the depressions 2 had a height of 0.05 μm from the work surface, although the shape and dimensions of the depressions 2 and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of wrinkles/warpage of the current collector made from the metal foil and of tear starting from wrinkles/warpage was checked. Also, an active material was disposed on both front and back sides of the current collector, and a cylindrical secondary battery was produced. At this time, the presence or absence of separation of the active material was checked.

Table 4 shows the above results.

TABLE 4

| | | | | Presence | | |
|---|---|---|---|---|---|---|
| | | | | or absence | Presence | |
| | | | Presence | of tear | or absence | |
| | | | or absence | starting | of | |
| | Height of | Presence | of | from | separation | |
| | bumps | or absence | wrinkles/ | wrinkles/ | of active | Comprehensive |
| | L1 (μm) | of adhesion | warpage | warpage | material | evaluation |
| Example 15 | 0.28 | Absent | Absent | Absent | Absent | ∘ |
| Example 16 | 0.1 | Absent | Absent | Absent | Absent | ∘ |
| Example 17 | 0.08 | Absent | Absent | Absent | Absent | ∘ |
| Comparative | 2.0 | Present | Present | Present | Absent | x |
| Example 7 | | | | | | |
| Comparative | 1.0 | Present | Present | Absent | Absent | x |
| Example 8 | | | | | | |
| Comparative | 0.5 | Present | Present | Absent | Absent | x |
| Example 9 | | | | | | |
| Comparative | 0.05 | Absent | Absent | Absent | Present | x |
| Example 10 | | | | | | |

In Examples 15 to 17, the height of the bumps 38 on the open edges of the depressions 2 formed in the outer surface 1a of the roller was in the range of 0.08 to 0.3 μm, and it was possible to prevent the failure of formation of the protrusions 7 having a desired shape by the roller. That is, these metal foils, which were the materials of the current collectors, were free from problems, such as wrinkles/warpage and tear starting from wrinkles/warpage, caused by the adhesion between the bumps 38 and the metal foil.

Contrary to this, in Comparative Examples 7 to 10 in which the heights of the bumps 38 were 2.0 μm, 1.0 μm, and 0.5 μm, respectively, the adhesion between the bumps 38 and the metal foil caused wrinkles/warpage. In particular, in Comparative Example 7 in which the height of the bumps 38 was 2.0 μm, the tear of the metal foil started from the bumps 38. Also, when the metal foil continuously separated due to the tear starting from wrinkles/warpage, the compression process could not be continued.

Further, in Examples 15 to 17, the active material was unlikely to separate from the surface of the current collector. The reason is probably as follows. In these Examples, the indentations 40 with a suitable depth were formed at the foot of the protrusions 7 of the metal foil. When the active material was disposed on the surface of the current collector, the active material was filled into the indentations 40.

In Comparative Example 10, the height of the bumps 38 was 0.05 μm, so the shape of the bumps 38 in the height direction could not be identified with a microscope of 1000 magnification. When the active material was disposed on the surface of this current collector, the amount of the electrode material mixture separated was 1.2 times those in Examples 15 to 17. This shows that the amount of separation is significantly large. Also, the separation of the active material significantly lowered the charge/discharge cycle characteristics of the secondary battery.

### Example 18

In the same manner as in Example 15, the depressions 2 were formed in a roller made of the same material as that used in Example 15, and the outer surface 1a was ground. Only the interval between the depressions 2 was changed. As a result, the area ratio: pressing plane/openings of depressions was 0.85, although the shape and dimensions of the depressions 2 and the height of the bumps 38 therearound were almost the same as those in Example 15.

Using such rollers, a metal foil serving as the material of a current collector was compressed to form the protrusions 7, and the presence or absence of problems, such as wrinkles/warpage of the current collector and tear starting from wrinkles/warpage, was checked. Also, the active material 42 was disposed on both front and back sides of the current collector, and a cylindrical secondary battery was produced. At this time, the presence or absence of separation of the active material 42 was checked. Also, the roller life was checked. The roller life as used herein is represented by the length of the current collector that has been worked until more than simple maintenance (e.g., brushing the roller surface with a brush) becomes necessary to form the protrusions 7 of desired shape.

### Example 19

In the same manner as in Example 15, the depressions 2 were formed in a roller made of the same material as that used in Example 15, and the outer surface 1a was ground. Only the interval between the depressions 2 was changed. As a result, the area ratio: pressing plane/openings of depressions was 0.55, although the shape and dimensions of the depressions 2 and the height of the bumps 38 therearound were almost the same as those in Example 15.

Using such rollers, a metal foil serving as the material of a current collector was compressed to form the protrusions 7, and the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked. Also, the roller life was checked.

### Example 20

In the same manner as in Example 15, the depressions 2 were formed in a roller made of the same material as that used in Example 15, and the outer surface 1a was ground. Only the interval between the depressions 2 was changed. As a result, the area ratio: pressing plane/openings of depressions was 0.50, although the shape and dimensions of the depressions 2 and the height of the bumps 38 therearound were almost the same as those in Example 15.

Using such rollers, a metal foil serving as the material of a current collector was compressed to form the protrusions 7, and the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked. Also, the roller life was checked.

### Example 21

In the same manner as in Example 15, the depressions 2 were formed in a roller made of the same material as that used in Example 15, and the outer surface 1a was ground. Only the interval between the depressions 2 was changed. As a result, the area ratio: pressing plane/openings of depressions was 0.10, although the shape and dimensions of the depressions 2 and the height of the bumps 38 therearound were almost the same as those in Example 15.

Using such rollers, a metal foil serving as the material of a current collector was compressed to form the protrusions 7, and the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked. Also, the roller life was checked.

### Example 22

In the same manner as in Example 15, the depressions 2 were formed in a roller made of the same material as that used in Example 15, and the outer surface 1a was ground. Only the interval between the depressions 2 was changed. As a result, the area ratio: pressing plane/openings of depressions was 0.05, although the shape and dimensions of the depressions 2 and the height of the bumps 38 therearound were almost the same as those in Example 15.

Using such rollers, a metal foil serving as the material of a current collector was compressed to form the protrusions 7, and the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked.

### Comparative Example 11

In the same manner as in Example 15, the depressions 2 were formed in a roller made of the same material as that used in Example 15, and the outer surface 1a was ground. Only the interval between the depressions 2 was changed. As a result, the area ratio: pressing plane/openings of depressions was 0.90, although the shape and dimensions of the depressions 2 and the height of the bumps 38 therearound were almost the same as those in Example 15.

Using such rollers, a metal foil serving as the material of a current collector was compressed to form the protrusions 7, and the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked. Also, the roller life was checked.

### Comparative Example 12

In the same manner as in Example 1, the depressions 2 were formed in a roller made of the same material as that used in Example 15, and the outer surface 1a was ground. Only the interval between the depressions 2 was changed. As a result, the area ratio: pressing plane/openings of depressions was 0.01, although the shape and dimensions of the depressions 2 and the height of the bumps 38 therearound were almost the same as those in Example 15.

Using such rollers, a metal foil serving as the material of a current collector was compressed to form the protrusions 7, and the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked. Also, the roller life was checked.

Table 5 shows the above results.

TABLE 5

| | | Presence or | Presence | Roller life | |
|---|---|---|---|---|---|
| | | absence | or absence | (length of | |
| | Area ratio | of | of | current | |
| | ΔS:pressing | wrinkles/ | separation | collector | |
| | plane/openings | warpage | of active | worked) | Comprehensive |
| | of depressions | and tear | material | (1000 m) | evaluation |
| Example 18 | 0.85 | Absent | Absent | 15 or more | ∘ |
| Example 19 | 0.55 | Absent | Absent | 15 or more | ∘ |
| Example 20 | 0.50 | Absent | Absent | 15 or more | ∘ |
| Example 21 | 0.10 | Absent | Absent | 13 | ∘ |
| Example 22 | 0.05 | Absent | Absent | 10 | ∘ |
| Comparative | 0.90 | Absent | Present | 15 or more | x |
| Example 11 | | | | | |
| Comparative | 0.01 | Present | Present | 1 or less | x |
| Example 12 | | | | | |

In Examples 18 to 22, the area ratio: pressing plane/openings of depressions is in the range of 0.05 to 0.85, and these current collectors were free from problems such as wrinkles/warpage and tear starting from wrinkles/warpage. Also, from the initial stage of the compression process, the metal foil was smoothly released from the bumps 38 on the outer surface 1a of the roller, and the compression process was not hindered, for example, by adhesion of foreign matter to the outer surface 1a of the roller. Also, at 10,000 m at which the life of the roller of Example 22 came to its end, the height of the protrusions 7 formed in each of Examples 18 to 22 was 6 μm or more.

In contrast, in Comparative Example 11 in which the area ratio: pressing plane/openings of depressions is 0.90, a large amount of the active material separated. This is probably because the area of the openings of the depressions is small and the height of the protrusions is also as short as approximately 1 μm. As such, it is thought that the adhesion of the active material to the current collector was weak in the same manner as in the case of disposing the active material on a metal foil having no protrusions. It is also thought that the separation of the active material is promoted by the distortion due to the pressurization of the base plane.

Also, in Comparative Example 11 in which the area ratio: pressing plane/openings of depressions is 0.01, wrinkles/warpage occurred, and the roller life was 1,000 m, which is extremely short. The reason for the occurrence of wrinkles/warpage is probably that the ratio of the pressing area is extremely low and the number of the depressions 2 per unit area is excessive. As such, it is thought that the pressing plane was streaked and that the metal foil was partially pressed by the very small area of the pressing plane. Hence, even plastic deformation in respective directions is unlikely to occur. Also, the pressure applied to the current collector in the width direction is unbalanced, so that the stretching of one end of the current collector in the width direction is greater than the stretching of the other end. Also, since the pressing area is small, the pressing plane becomes streaked, and it wears down at a high speed, resulting in a short life of the roller.

### Example 23

In the same manner as in Example 15, the depressions 2 were formed in a roller made of the same material as that used in Example 15, and the outer surface 1a was ground. Only the depth of the depressions 2 was changed. As a result, the depth of the depressions 2 was 15 μm, although the shape of the depressions 2, the height of the bumps 38 therearound, and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked.

### Example 24

In the same manner as in Example 15, the depressions 2 were formed in a roller made of the same material as that used in Example 15, and the outer surface 1a was ground. Only the depth of the depressions 2 was changed. As a result, the depth of the depressions 2 was 10 μm, although the shape of the depressions 2, the height of the bumps 38 therearound, and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked.

### Example 25

In the same manner as in Example 15, the depressions 2 were formed in a roller made of the same material as that used in Example 15, and the outer surface 1a was ground. Only the depth of the depressions 2 was changed. As a result, the depth of the depressions 2 was 5.0 μm, although the shape of the depressions 2, the height of the bumps 38 therearound, and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked.

### Example 26

In the same manner as in Example 15, the depressions 2 were formed in a roller made of the same material as that used in Example 15, and the outer surface 1a was ground. Only the depth of the depressions 2 was changed. As a result, the depth of the depressions 2 was 1.0 μm, although the shape of the depressions 2, the height of the bumps 38 therearound, and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked.

### Comparative Example 3

In the same manner as in Example 15, the depressions 2 were formed in a roller made of the same material as that used in Example 15, and the outer surface 1a was ground. Only the depth of the depressions 2 was changed. As a result, the depth of the depressions 2 was 20 μm, although the shape of the depressions 2, the height of the bumps 38 therearound, and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of problems, such as wrinkles/warpage of the current collector and tear starting from wrinkles/warpage, was checked. Also, an active material was disposed on both front and back sides of the current collector, and a cylindrical secondary batter was produced. At this time, the presence or absence of separation of the active material was checked.

### Comparative Example 14

In the same manner as in Example 15, the depressions 2 were formed in a roller made of the same material as that used in Example 15, and the outer surface 1a was ground. Only the depth of the depressions 2 was changed. As a result, the depth of the depressions 2 was 0.5 μm, although the shape of the depressions 2, the height of the bumps 38 therearound, and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked.

### Comparative Example 15

In the same manner as in Example 15, the depressions 2 were formed in a roller made of the same material as that used in Example 15, and the outer surface 1a was ground. Only the depth of the depressions 2 was changed. As a result, the depth of the depressions 2 was 0.01 μm, although the shape of the depressions 2, the height of the bumps 38 therearound, and the area ratio: pressing plane/openings of depressions were almost the same as those in Example 15.

Using such rollers, a metal foil serving as the material of a current collector was compressed to form the protrusions 7, and the presence or absence of adhesion of the metal foil to the roller was checked. Also, the presence or absence of problems, such as wrinkles/warpage of the current collector and tear starting from wrinkles/warpage, was checked. Also, an active material was disposed on both front and back sides of the current collector, and a cylindrical secondary battery was produced. At this time, the presence or absence of separation of the active material was checked.

Table 6 shows the above results.

TABLE 6

| | | | | Presence or | |
|---|---|---|---|---|---|
| | | | Presence or | absence of | |
| | Depth of | Presence or | absence of | electrode | |
| | depressions | absence of | wrinkles/warpage | material | Comprehensive |
| | (μm) | adhesion | and tear | mixture | evaluation |
| Example 23 | 15 | Absent | Absent | Absent | ∘ |
| Example 24 | 10 | Absent | Absent | Absent | ∘ |
| Example 25 | 5.0 | Absent | Absent | Absent | ∘ |
| Example 26 | 1.0 | Absent | Absent | Absent | ∘ |
| Comparative | 20 | Present | Present | Absent | x |
| Example 13 | | | | | |
| Comparative | 0.5 | Absent | Absent | Absent | x |
| Example 14 | | | | | |
| Comparative | 0.01 | Absent | Absent | Present | x |
| Example 15 | | | | | |

In Examples 23 to 26 in which the depth of the depressions 2 is 1.0 to 15 μm, it was possible to prevent the failure of formation of the protrusions 7 having a desired shape. That is, these metal foils, which were the materials of the current collectors, were free from problems such as wrinkles/warpage caused by the adhesion between the bumps 38 and the metal foil. Further, the indentations 40 with a suitable depth are formed at the foot of the protrusions 7 of the metal foil due to the pressurization by the burrs on the roller surface. Thus, when the active material is disposed on the surface of the current collector, the active material is filled into the indentations 40. This was found to help prevent the separation of the active material from the surface of the current collector 6.

On the other hand, in Comparative Example 13 in which the depth of the depressions 2 is 20 μm, it is necessary to increase the compressive pressure in order to form the protrusions 7 having such a depth. When the height of the protrusions 7 exceeded 10 μm, the separation of the metal foil from the roller became difficult and the metal foil adhered to the bumps 38 on the open edges of the depressions 2. As a result, the worked current collector exhibited problems such as wrinkles/warpage and tear starting from wrinkles/warpage.

In Comparative Example 14 and Comparative Example 15, the depth of the depressions 2 was 0.5 μm or 0.01 μm, which is extremely shallow, and the shape of the depressions 2 in the depth direction could not be identified with a microscope of 1000 magnification. When such rollers were used to compress the metal foil for forming the current collector, and the active material was disposed on the surface thereof, the amount of the active material separated was 1.3 times that when the depth of the depressions 2 was 1.0 μm or more. That is, the amount of separation significantly increased.

### Example 27

In the same manner as in Example 15, the depressions 2 were formed in a roller made of the same material as that used in Example 15. At this time, for example, the energy of the laser beam applied to the outer surface 1a of the roller was adjusted so that the height L0 of the burrs 36 formed on the open edges of the depressions 2 was 0.5 to 1 μm, and the laser beam was applied to the same position a plurality of times. In this way, the depressions 2 with approximately the same depth as that in Example 15 were formed. Thereafter, without grinding the outer surface 1a, a pre-conditioning interim process was performed approximately 10 m by surface pressurization at a linear pressure of 1 t/cm. As a result, the height L1 of the bumps 38 on the open edges of the depressions 2 was 0.12 μm, although the shape and dimensions of the depressions 2 and the area ratio: pressing plane/openings of depressions were almost the same as those in Example 15.

Using such rollers, a metal foil serving as the material of a current collector was compressed to form the protrusions 7, to obtain the current collector 6. In this case, by performing a pre-conditioning interim process approximately 10 m, the burrs were released and removed from the outer surface 1a of the roller while being crushed. Thereafter, by compressing the metal foil by a pair of rollers, a current collector having very few wrinkles/warps could be produced. Further, the roller life in Example 27 until the occurrence of wearing of the outer surface 1a of the roller and the adhesion of the metal foil was 15,000 m, which indicated that the roller life is long enough to justify mass production costs. In Table 7, the roller life is expressed as an index relative to 15,000 m. Therein, the separation of the active material formed on the current collector surface was not evaluated.

### Example 28

In the same manner as in Example 15, the depressions 2 were formed in a roller made of the same material as that used in Example 15, and the outer surface 1a was ground by sheet grinding using a diamond paste. As a result, the height of the bumps around the depressions 2 was 0.12 μm, although the shape and dimensions of the depressions 2 and the area ratio: pressing plane/openings of depressions were almost the same as those in Example 15.

Using such rollers, a metal foil serving as the material of a current collector was compressed to form the protrusions 7, to obtain a current collector. In this case, a current collector having very few wrinkles/warps could be produced without performing a pre-conditioning interim process as in Example 27. In addition, the roller life was 16700 m, which was 11% better than that in Example 27.

### Comparative Example 16

In the same manner as in Example 15, the depressions 2 were formed in a roller made of the same material as that used in Example 15. At this time, for example, the energy of the laser beam applied to the outer surface 1a of the roller was adjusted so that the height LO of the burrs formed on the open edges of the depressions 2 was 0.5 to 1 μm, and the laser beam was applied to the same position a plurality of times. In this way, the depressions 2 with approximately the same depth as that in Example 15 were formed. The outer surface 1a was not ground. As a result, the height of the bumps 38 on the open edges of the depressions 2 was 0.75 μm, although the shape and dimensions of the depressions 2 and the area ratio: pressing plane/openings of depressions were almost the same as those in Example 15.

The indentations 40 with a depth of approximately 0.6 μm were formed in the current collector 6, but when the current collector 3 was compressed by the rollers, it tore from wrinkles/warpage. The result is shown in the Table. The tear of the current collector 6 and the adhesion of the metal foil to a large number of the depressions 2 indicated that the non-ground roller is not usable. The life thereof was immeasurably short.

### Comparative Example 17

In the same manner as in Example 15, the depressions 2 were formed in a roller made of the same material as that used in Example 15. The outer surface 1a of the roller was ground by tape grinding. As a result, the height of the bumps 38 on the open edges of the depressions 2 was 0.3 μm, although the shape and dimensions of the depressions 2 and the area ratio: pressing plane/openings of depressions were almost the same as those in Example 15.

The tape grinding was carried out by a grinding method in which abrasive grains with the same particle size were attached to the base material on the surface of a hoop-like tape, and the tape was brought into contact with the outer surface 1a of the roller while being transported. According to tape grinding, grinding by an always new surface is possible. However, according to this method, when burrs of 1 μm or more are ground, the circularity of the roller undesirably becomes less than 2 μm, resulting in problems. For example, the depth of the depressions 2 becomes partially too shallow, or their shapes vary. As a result, the current collector became wrinkled/warped and the roller life was shortened to 10500 m. The roller life was reduced to 70% of that of Example 13. The reason why such problems occurred in this Comparative Example is probably variations in the shape of the depressions 2, and the like.

### Comparative Example 18

In the same manner as in Example 15, the depressions 2 were formed in a roller made of the same material as that used in Example 15. The outer surface 1a of the roller was ground by cylindrical grinding. As a result, the height of the bumps around the depressions 2 was 0.3 μm, although the shape and dimensions of the depressions 2 and the area ratio: pressing plane/openings of depressions were almost the same as those in Example 15.

Cylindrical grinding is a common grinding method in the roll industry. It is a highly versatile grinding method. When using this method to grind the burrs on the outer surface la of the roller, it is necessary to mount the roller in a grinding machine. Thus, even when using a high precision grinding machine, it is necessary to grind the outer surface la of the roller approximately 3 to 5 μm in order to provide a base surface, thereby resulting in problems. For example, the depth of the depressions 2 partially becomes too shallow, or their shapes vary. As a result, the current collector became wrinkled/warped and the roller life was shortened to 2000 m. The roller life was reduced to 13% of that of Example 13. The reason why such problems occurred in this Comparative Example is probably variations in the shape of the depressions 2, and the like.

### Comparative Example 19

In the same manner as in Example 15, the depressions 2 were formed in a roller made of the same material as that used in Example 15. The outer surface 1a of the roller was ground by belt grinding. As a result, the height of the bumps 38 on the open edges of the depressions 2 was 0.3 μm, although the shape and dimensions of the depressions 2 and the area ratio: pressing plane/openings of depressions were almost the same as those in Example 15.

In belt grinding, a relatively short endless belt, both ends of which are joined, is pressed against a roller with an abrasive applied thereto, to grind the outer surface la of the roller. That is, the pressure created by the tension of the belt is utilized for grinding. Belt grinding is a grinding method that is widely applicable regardless of the shape of a work.

However, in belt grinding, since the belt is worn down by the powder of 1 μm or more produced as a result of the grinding of the burrs, the surface roughness does not become uniform, thereby resulting in problems. For example, the depth of the depressions 2 partially becomes too shallow, or their shapes vary. As a result, the current collector became wrinkled/warped and the roller life was shortened to 9 m. The roller life was 0.06% of that of Example 13. The reason why such problems occurred in this Comparative Example is probably variations in the shape of the depressions 2, and the like.

### Comparative Example 20

In the same manner as in Example 15, the depressions 2 were formed in a roller made of the same material as that used in Example 15. The outer surface 1a of the roller was ground by vertical grinding. As a result, the height of the bumps 38 on the open edges of the depressions 2 was 0.3 μm, although the shape and dimensions of the depressions 2 and the area ratio: pressing plane/openings of depressions were almost the same as those in Example 15.

Vertical grinding is a grinding method according to the above-mentioned cylindrical grinding in which a grindstone is pressed against differently. It is a method commonly used for precision finish. When using this method to grind the burrs on the outer surface 1a of the roller, it is also necessary to mount the roller in a grinding machine. Thus, even when using a high precision grinding machine, it is necessary to grind the outer surface 1a of the roller approximately 3 μm in order to provide a base surface, thereby resulting in problems. For example, the depth of the depressions 2 partially becomes too shallow, or their shapes vary. As a result, the current collector became wrinkled/warped and the roller life was shortened to 4000 m. The roller life was reduced to 27% of that of Example 13. The reason why such problems occurred in this Comparative Example is probably variations in the shape of the depressions 2, and the like.

Table 7 shows the above results.

TABLE 7

| | | | Height of | | | |
|---|---|---|---|---|---|---|
| | | Height of | bumps | | | |
| | | burrs on the | after | Presence | | |
| | | open edges | grinding | or absence | | |
| | | of | for 20 | of | Index for | |
| | | depressions | minutes | wrinkles/ | roll life | |
| | Grinding method | (μm) | (μm) | warpage | (%) | Evaluation |
| Example 27 | No grinding | 0.8 | 0.12 | ∘ | 100 | ∘ |
| | (pre- | | | | | |
| | conditioning | | | | | |
| | interim process | | | | | |
| | by surface | | | | | |
| | pressurization) | | | | | |
| Example 28 | Sheet grinding | 0.8 | 0.12 | ∘ | 111 | ∘ |
| Comparative | No grinding | 1.0 | 0.75 | x | Not | x |
| Example 16 | | | | | measurable | |
| Comparative | Tape grinding | 0.9 | 0.3 | x | 70 | x |
| Example 17 | | | | | | |
| Comparative | Cylindrical | 0.84 | 0.3 | x | 13 | x |
| Example 18 | grinding | | | | | |
| Comparative | Belt grinding | 0.92 | 0.3 | x | 0.06 | x |
| Example 19 | | | | | | |
| Comparative | Vertical | 0.78 | 0.3 | x | 27 | x |
| Example 20 | grinding | | | | | |

### Example 29

The roller diameter was set to 125 mm. The rollers were heated to 50° C. A copper foil was used as the metal foil. The metal foil was pressed with a Hertzian pressure of 200 N/mm². Except for these, in the same manner as in Example 15, a current collector 6 was produced. At this time, the separation force required for releasing the current collector from the rollers and the warpage and wrinkles of the current collector produced were checked.

### Example 30

The rollers were heated to 100° C. Except for this, in the same manner as in Example 29, a current collector was produced. At this time, the separation force required for releasing the current collector from the rollers and the warpage and wrinkles of the current collector produced were checked.

### Example 31

The rollers were heated to 150° C. Except for this, in the same manner as in Example 29, a current collector was produced. At this time, the separation force required for releasing the current collector from the rollers and the warpage and wrinkles of the current collector produced were checked.

### Example 32

The rollers were heated to 200° C. Except for this, in the same manner as in Example 29, a current collector was produced. At this time, the separation force required for releasing the current collector from the rollers and the warpage and wrinkles of the current collector produced were checked.

### Example 33

The rollers were heated to 250° C. Except for this, in the same manner as in Example 29, a current collector was produced. At this time, the separation force required for releasing the current collector from the rollers and the warpage and wrinkles of the current collector produced were checked.

Table 8 shows the above results.

TABLE 8

| | Separation | Warpage | |
|---|---|---|---|
| | force (N) | (mm) | Wrinkles |
| Example 29 | 0.8 | 0.8 | Small ones confirmed |
| Example 30 | 0.2 | 0.8 | Very small ones |
| | | | confirmed |
| Example 31 | 0.08 | 0.8 | Very small ones |
| | | | confirmed |
| Example 32 | 3.2 | 0.8 | None |
| Example 33 | 3.2 | 0.8 | None |

As is clear from Table 8, in all the Examples, the occurrence of wrinkles/warpage was reduced in comparison with the case of not heating the rollers. This is probably because the heating of the rollers increased the separation property of the solid lubricant, thereby improving the releasability of the current collector from the rollers. Also, in Examples 32 and 33 in which the heating temperature is high, wrinkles and warpage could be significantly suppressed. This is probably because heating the current collector to a relatively high temperature could produce essentially the same effect as applying an annealing process.

### INDUSTRIAL APPLICABILITY

In a method for producing a battery current collector and a battery current collector according to the invention, the battery current collector has sufficient strength, and an active material can be efficiently disposed on protrusions formed on the current collector. It is therefore possible to obtain a highly reliable battery. The battery is useful, for example, as the power source for portable electronic devices, which is required to provide a higher capacity as electronic devices and communications devices are increasingly becoming more sophisticated.

1. A battery current collector comprising a metal foil for carrying at least a positive electrode active material or a negative electrode active material,
wherein at least one side of the metal foil has a compressed base plane and non-compressed protrusions arranged at a predetermined interval, the non-compressed protrusions being formed at the same time as formation of the base plane, and
the surface roughness of the base plane is different from the surface roughness of the protrusions.

2. The battery current collector in accordance with claim 1, wherein the surface roughness of the protrusions is greater than the surface roughness of the base plane.

3. The battery current collector in accordance with claim 1, wherein the surface roughness of the base plane is an arithmetic mean roughness of 0.8 μm or less.

4. A method for producing a battery current collector, comprising the step of pressing at least one side of a metal foil to form protrusions on the at least one side of the metal foil at a predetermined interval,
wherein the step comprises pressing the metal foil with a work tool having depressions in a work surface at a predetermined interval, thereby to form a compressed base plane at an area of the metal foil corresponding to an area of the work surface excluding the depressions, and at the same time, to form the protrusions at areas of the metal foil corresponding to the depressions, the protrusions being not compressed and having a surface roughness different from that of the base plane.

5. The method for producing a battery current collector in accordance with claim 4, wherein the base plane is so formed that the surface roughness of the base plane is an arithmetic mean roughness of 0.8 ∞m or less.

6. The method for producing a battery current collector in accordance with claim 4, wherein the metal foil is pressed with a pair of rollers as the work tool, at least one of the pair of rollers having the depressions.

7. The method for producing a battery current collector in accordance with claim 6, further comprising placing a lubricant between the work surface of the roller and the metal foil before pressing the metal foil.

8. The method for producing a battery current collector in accordance with claim 6, comprising heating the roller to 50 to 120° C.

9. The method for producing a battery current collector in accordance with claim 7, wherein the lubricant is at least one selected from the group consisting of myristic acid, stearic acid, caprylic acid, capric acid, lauric acid, oleic acid, and ether compounds.

10. The method for producing a battery current collector in accordance with claim 7, comprising:
mixing the lubricant with at least one of an organic dispersion medium and an aqueous dispersion medium to form a solution;
applying the solution onto at least one of the metal foil and the work surface of the roller; and
drying it so that the lubricant is placed between the metal foil and the work surface of the roller.

11. The method for producing a battery current collector in accordance with claim 4, wherein a cross-section of each of the depressions perpendicular to the work surface of the work tool has a taper so that the width of the cross-section parallel to the work surface gradually decreases from an opening of the depression to a bottom of the depression.

12. The method for producing a battery current collector in accordance with claim 11, wherein the taper has an angle of 5 to 60°.

13. The method for producing a battery current collector in accordance with claim 4, wherein an edge of an opening of each of the depressions of the work tool has a curvature radius of 3 to 100 μm.

14. The method for producing a battery current collector in accordance with claim 4, wherein a pressing area is defined as the area obtained by subtracting the area of openings of the depressions of the work tool from the area of the whole work surface, and the ratio of the pressing area to the area of openings of the depressions is from 0.05 to 0.85.

15. The method for producing a battery current collector in accordance with claim 6,
wherein the roller comprises a core portion and an outer portion,
the core portion comprises a quenched alloy composed mainly of iron, and
the outer portion comprises a quenched alloy composed mainly of iron, a super hard alloy, or ceramics with a porosity of 5% or less.

16. The method for producing a battery current collector in accordance with claim 6, comprising using the roller, wherein the work surface comprises a coating of ceramics with a porosity of 5% or less or a super hard alloy.

17. The method for producing a battery current collector in accordance with claim 15, wherein the ceramics is formed by CVD, PVD, or thermal spraying of at least one selected from the group consisting of: amorphous carbon; diamond-like carbon; titanium oxide; titanium nitride; titanium carbonitride; and oxides, nitrides, and carbides composed mainly of zirconium, silicon, chromium, and aluminum.

18. The method for producing a battery current collector in accordance with claim 15, the super hard alloy is tungsten carbide having a mean particle size of 5 μm or less and containing at least cobalt or nickel as a binder, and
the super hard alloy has a Rockwell A scale hardness of 82 or more and is formed by CVD, PVD, or thermal spraying.

19. The method for producing a battery current collector in accordance with claim 4, wherein an edge of opening of each of the depressions of the work tool has a bump with a height of 0.08 to 0.3 μm from the work surface.

20. The method for producing a battery current collector in accordance with claim 19, wherein the bump has a curvature radius of 15 μm or less.

21. The method for producing a battery current collector in accordance with claim 4, wherein the depressions of the work tool are formed by irradiating the work surface with a laser beam.

22. The method for producing a battery current collector in accordance with claim 4, wherein an opening of each of the depressions of the work tool is shaped like any one of a substantial circle, a substantial oval, a substantial rhombus, a substantial rectangle, a substantial square, a substantially regular hexagon, and a substantially regular octagon.

23. A non-aqueous secondary battery comprising:
a positive electrode plate comprising a positive electrode current collector and a positive electrode mixture paint applied to the positive electrode current collector, the positive electrode mixture paint comprising an active material comprising at least a lithium-containing composite oxide, a conductive agent, and a binder which are dispersed in a dispersion medium;
a negative electrode plate comprising a negative electrode current collector and a negative electrode mixture paint applied to the negative electrode current collector, the negative electrode mixture paint comprising an active material comprising at least a material capable of retaining lithium and a binder which are dispersed in a dispersion medium;
a separator; and
an electrolyte comprising a non-aqueous solvent,
wherein at least one of the positive electrode current collector and the negative electrode current collector is the battery current collector recited in claim 1.
